(19) United States
(12) Patent Application Publication
(10) Pub. No.: US 2026/0092832 A1
(43) Pub. Date: Apr. 2, 2026

(54) METHOD AND SYSTEM FOR BEARING FAULT TYPE DETERMINATION

(71) Applicant: NAJRAN UNIVERSITY, Najran (SA)

(72) Inventors: Muhammad IRFAN, Najran (SA); Zohaib MUSHTAQ, Sargodha (PK); Nabeel Ahmed KHAN, Islamabad (PK); Faisal ALTHOBIANI, Jeddah (SA); Salim Nasar Faraj MURSAL, Najran (SA); Saifur RAHMAN, Najran (SA); Muawia Abdelkafi MAGZOUB, Omdurman (SD); Muhammad Armghan LATIF, Cleveland, OH (US); Imran Khan YOUSUFZAI, Sargodha (PK)

(73) Assignee: NAJRAN UNIVERSITY, Najran (SA)

(21) Appl. No.: 18/903,512

(22) Filed: Oct. 1, 2024

(51) Int. Cl. G01M 13/045; G06T 7/00

(52) U.S. Cl. CPC G01M 13/045; G06T 7/0004; G06T 2207/20081

(57) ABSTRACT

A method of determining a type of fault of a bearing in a machine includes obtaining vibration signal data that is representative of characteristics of a bearing in a machine, including a one-dimensional time domain signal. The method further includes converting the vibration signal data to a first image, which is a two-dimensional grayscale image representation of the vibration signal data. The method further includes executing a fault prediction model by inputting the first image to determine a type of fault in the bearing. The execution includes extracting, using a feature extraction model, multiple feature vectors from the first image that are representative of the characteristics of the bearing. The feature vectors are extracted using location-agnostic convolution operation and location-specific involution operation. The executing further includes determining, by the fault prediction model, the type of fault in the bearing based on the feature vectors.

### STATEMENT OF ACKNOWLEDGEMENT

Support provided by the Deanship of Scientific Research, Najran University. Kingdom of Saudi Arabia, for funding this work under the Distinguished Research funding program grant code number (NU/DRP/SERC/12/8) is gratefully acknowledged.

### STATEMENT OF PRIOR DISCLOSURE BY AN INVENTOR

Aspects of the present disclosure were described in M. Irfan et al., “Improving Bearing Fault Identification by Using Novel Hybrid Involution-Convolution Feature Extraction With Adversarial Noise Injection in Conditional GANs,” IEEE Access, vol. 11, pp. 118253-118267, 2023 which is incorporated herein by reference in its entirety.

### BACKGROUND

### Technical Field

The present disclosure relates to the field of fault identification and diagnosis in machines. More specifically, the present disclosure pertains to methods and systems for detecting and classifying faults in bearings using advanced machine learning techniques, particularly in the context of rotating machinery in industrial settings.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Rotating machinery is a key component in the manufacturing sector, playing a critical role in various industrial processes. As industrial needs expand, the complexity and sophistication of these machines continue to increase. Bearings, being essential components, reduce friction and support movement in rotating machinery, but they are vulnerable to defects such cage problems, rolling element corrosion, and inner and outer race abnormalities. Bearings are subject to wear, aging, and potential failure due to continuous high-speed operation during production. The failure of bearings can lead to severe consequences, including safety hazards, equipment damage, production disruptions, and significant financial losses. Therefore, it is advantageous that any defects in bearings be found early in order to prevent serious failures and downtime.

Traditional reactive maintenance approaches, which depend on malfunctions or noticeable symptoms, frequently result in more severe deterioration and expensive emergency fixes. Regular inspections require a lot of resources, which disrupts schedules and results in severe downtime. For example, unplanned downtime costs offshore firms $38 million on average a year, and in the worst circumstances, more than $88 million. A 1% annual downtime rate costs more than $5 million, demonstrating the significant financial impact. In spite of this, time-based or reactive maintenance is still used by 75% of oil and gas companies, with less than 24% using predictive solutions. The three main diagnostic methods are temperature monitoring, vibration analysis, and sound emission analysis.

To address these challenges, advanced diagnostic methods have been developed for bearing fault detection. These methods include temperature monitoring, vibration analysis, ultrasound analysis, and electrical discharge analysis. Among these, vibration signal analysis has gained prominence due to its effectiveness in detecting bearing faults and the relative simplicity of data collection and processing. When a bearing's surface is partially damaged, it produces a periodic broadband pulse excitation signal, making vibration analysis highly effective for assessing the condition of rolling bearings.

Conventional approaches to vibration-based bearing fault diagnosis have relied on time-domain, frequency-domain, and time-frequency domain analyses of vibration signals. Common techniques include wavelet transform, empirical mode decomposition, and local mean decomposition. These methods extract characteristics that are then used to discern fault conditions through basic machine learning techniques such as random forests. However, these traditional techniques have limitations. They often depend on domain-specific knowledge, struggle to learn complex features, and lack the adaptability needed to handle situations involving substantial integration and intricate operational conditions.

In recent years, deep learning algorithms, particularly Convolutional Neural Networks (CNNs), have emerged as powerful tools for bearing fault diagnosis. These algorithms can learn features adaptively and extract them directly from raw vibration signals, eliminating the need for manual feature extraction. This approach offers more efficient, accurate, and generalizable fault diagnosis. Researchers have used deep neural networks to evaluate the deterioration degree of rolling bearings based on fault feature information extracted from vibration signals.

Since deep learning techniques are highly data dependent, it is advantageous to acquire large datasets and annotate them for optimal condition monitoring. As data acquisition and annotation is time consuming, labor intensive and expensive, there is always a possibility of models failing to generalize well and be susceptible to biases because of class imbalances. The effects of imbalance are significant in condition monitoring systems, where the usual operational state is normal—resulting in excess fault-free data. To remedy this, simulations and experimental test beds are employed to acquire fault data in controlled settings by seeding the bearings with faults using various techniques like electro-discharge machining (EDM). Although these settings provide access to the fault data, there is still a significant imbalance seen in different fault types because of the difficulty in emulating some fault signatures especially those at the initial stages or at the critical stages. Moreover, the datasets acquired in these controlled settings lack diversity and variations which can affect generalization.

One approach to enhancing the performance of CNNs in bearing fault diagnosis involves transforming one-dimensional vibration signals into two-dimensional representations, such as matrices or spectral images. This transformation allows CNNs to harness their feature extraction capabilities more effectively, resulting in more precise feature detection. Some researchers have further refined this approach by preprocessing the signals to amplify hidden patterns, aiming for more robust and reliable diagnosis. However, a significant challenge in bearing fault diagnosis is the imbalance between normal and fault classes in most datasets. This imbalance presents a fundamental challenge in effectively training machine learning models. Two main approaches have been developed to address this issue. The first focuses on enhancing the effectiveness of cost-sensitive algorithms to improve fault diagnosis accuracy when dealing with a scarcity of fault samples. The second approach centers around data augmentation techniques, including oversampling and undersampling, to address class imbalance.

Generative Adversarial Networks (GANs) have shown promise in addressing the challenge of imbalanced datasets in bearing fault diagnosis. GAN models are proficient in generating diverse samples that share similar distribution yet unique in their composition. GANs can be used to generate synthetic samples of underrepresented fault classes, potentially improving the performance of fault diagnosis models. However, GAN-based methods face their own challenges, including model collapse due to small training sizes, vanishing and exploding gradients in deep networks, and susceptibility to adversarial attacks.

Another complication within the deep learning-based condition monitoring pipeline stems from the adversarial attempts. These attempts are intended to compromise the integrity of classification or data generation pipeline, resulting in flawed outcomes. Similarly, the ambient noise can also interfere with the model's distinguishing capabilities during the inference stages, bringing forth lethal consequences. As an uninformed bearing failure has a capacity to affect neighboring components of the machinery, increasing the possibility of safety hazards and economic smites. Furthermore, there is a need for the development of deep learning algorithms that are not only computationally efficient but also highly effective in diagnostic applications. The utility of an algorithm is significantly diminished if it cannot be deployed in real-time operational environments. In this context, it is observed that while new bearing fault classification techniques are frequently introduced, boasting impressive results, the computational demands often hinder their practical implementation in industrial settings. Although standard convolutional operations are capable of extracting features efficiently, they are not always optimized for specific use cases. Numerous variants of convolutional operations are being designed to address specific challenges, such as vanishing gradients, computational efficiency, and feature extraction for small-scale objects.

CN116805050A discloses a centrifugal pump fault diagnosis method and device based on a conditional generative adversarial network. This method involves collecting real-time vibration signals of centrifugal pump bearings and processing these signals to diagnose faults. The vibration signals are pre-processed to enhance signal quality by filtering noise and extracting periodic features. After pre-processing, a fault diagnosis model is employed, which assesses data balance and generates virtual samples of unbalanced data using a trained conditional generative adversarial network (CGAN). These virtual samples, along with real samples, are then used to train a convolutional neural network to diagnose faults in the centrifugal pump. This reference describes the use of a CGAN to address data imbalance issues commonly encountered in centrifugal pump fault diagnosis. However, it does not use a hybrid feature extraction network, such as a combination of convolution and involution operations, for improved feature extraction from 1D time-domain signals, nor does it involve a framework that introduces adaptive adversarial noise during GAN training for enhancing model response to adversarial attacks.

Therefore, there remains a need for more effective methods of bearing fault diagnosis that can address challenges currently faced in industrial applications. One of the primary challenges is the issue of imbalanced datasets, where fault data is significantly underrepresented compared to normal operating data. This imbalance often leads to biased model training and reduced diagnostic accuracy, particularly in detecting early-stage or rare faults. In addition, there is a need for methods that can generate high-quality synthetic samples that closely mimic real-world fault conditions. These synthetic samples must not only enhance the diversity of training data but also improve the model's ability to generalize across different operating scenarios. Moreover, the diagnostic methods must provide highly accurate classification of various types of bearing faults, including inner race, outer race, and rolling element defects, even in noisy and dynamic industrial environments. The solution must also be computationally efficient, enabling real-time deployment on resource-constrained systems such as edge devices or industrial monitoring systems.

Accordingly, it is one object of the present disclosure to provide a method and system of determining a type of fault of a bearing in a machine, which provides a robust framework for efficient and secure sample generation via GAN (CC-GAN) by the introduction of adaptive adversarial noise. The present disclosure addresses the aforementioned needs by using a conditional GAN based oversampling algorithm with the spectral normalization and adaptive adversarial noise injection approach to generate high quality bearing fault samples for the minority classes. Moreover, the proposed GAN based method effectively counters the mode collapse and vanishing gradients. Additionally, a combination of involution and convolution-based feature extraction is used to capture the channel-agnostic, spatial specific and spatial agnostic and channel specific features from the faulty bearings. The proposed approach provides a well-rounded understanding of the data, yielding both local and global insights crucial for accurate and reliable rolling bearing diagnosis.

### SUMMARY

In an exemplary embodiment, a method of determining a type of fault of a bearing in a machine is described. The method comprises obtaining vibration signal data that is representative of characteristics of a bearing in a machine. Herein, the vibration signal data includes a one-dimensional time domain signal. The method further comprises converting the vibration signal data to a first image. Herein, the first image is a two-dimensional grayscale image representation of the vibration signal data. The method further comprises executing a fault prediction model by inputting the first image to determine the type of fault in the bearing. The execution includes extraction of fault information/signatures, using the feature extraction model with multiple feature vectors extracted from the first-image that are representative of the characteristics of the bearing. The feature vectors are extracted using location-agnostic convolution operation and location-specific involution operation. The execution further includes determining, by the fault prediction model, the type of fault in the bearing based on the feature vectors.

In some embodiment, extracting the feature vectors includes performing a convolution operation via the convolutional branch on the first input image to obtain a first set of feature vectors that have location-agnostic and channel-specific features of the first image. Similarly, the extraction of the feature vectors further includes performing an involution operation on the first input image via the involution branch to obtain a second set of feature vectors that have location-specific and channel-agnostic features of the input image. The extraction of the feature vectors further includes concatenating the first set of feature vectors and the second set of feature vectors to generate a concatenated set of feature vectors, which is used as an input to the fault prediction model to determine the type of fault.

In some embodiments, the method further comprises obtaining, using an image generation model, multiple fault images from noise data. Herein, different sets of the generated fault images are associated with different fault types. Further, the image prediction model is trained alongside a generation model to generate a specified fault image for a specified fault type from input noise image.

In some embodiments, the method further comprises training the fault prediction model with the fault images as training data to predict a fault type of the bearing for an encoded input image.

In some embodiments, the training includes generating a feature vector combination from a first fault image of the fault images. Herein, the feature vector combination is a combination of (a) location-agnostic and channel-specific features and (b) location-specific and channel-agnostic features of the first fault image. The training further includes generating a predicted fault type associated with the first fault image based on the feature vector combination. The training further includes performing the training until a first loss function associated with the fault prediction model is reduced. The first loss function is indicative of a difference between ground-truth fault type associated with the first fault image and the predicted fault type.

In some embodiments, the method further comprises training the image generation model using training data to generate the specified fault image for the specified fault type. The training data includes multiple sets of data. Each set of data includes (a) noise image, (b) a ground-truth fault image representative of one of the types of a fault, and (c) a fault type associated with the ground-truth fault image. Herein, the training includes generating, using a generator of the image generation model, a predicted fault image based on the noise image and the fault type. The training further includes determining, using a discriminator of the image generation model, whether a difference between the predicted fault image and the ground-truth fault image is less than a specified threshold. The training further includes iteratively training the image prediction model until the difference is reduced.

In some embodiments, training the image prediction model includes applying spectral normalization to adjust a Lipschitz constant of the discriminator.

In some embodiments, training the image generation model includes determining, using a noise generator model, a noise controlling parameter, which is used to control amount of noise added to the noise image. The training of the image generation model further includes modifying the noise image based on the noise controlling parameter to generate noisy image data. The training of the image prediction model further includes inputting the noisy image data to the generator to generate the predicted fault image.

In some embodiments, determining the noise controlling parameter includes obtaining a loss associated with the generator during first stage training of the image generation model. The determining the noise controlling parameter further includes determining, using the noise generator model, the noise controlling parameter based on the generator loss.

In some embodiments, the noise controlling parameter includes a first noise controlling parameter and a second noise controlling parameter that is used to add noise to the noise image. The first noise controlling parameter is greater than the second noise controlling parameter.

In some embodiments, determining the noise controlling parameter includes generating a plurality of noise generation model's training datasets. Each noise generation model's training dataset includes a loss associated with a generator of a second image generation model and multiple noise controlling parameters generated for the loss. The noise controlling parameters include a first noise controlling parameter that is computed when the loss is greater than a threshold loss, and a second noise controlling parameter that is computed when the loss is lesser than or equal to the threshold loss. The determining the noise controlling parameter further includes training the noise generator model with the noise training datasets to generate the noise controlling parameter.

In some embodiments, generating the plurality of noise training datasets includes training the second image prediction model to generate a training image that is representative of a given type of fault. Herein, the training includes generating, using the generator of the second image generator model, the training image based on random image data. The training further includes determining, using a discriminator of the second image prediction model, whether a difference between the training image and a source image representative of the given type of fault is less than a specified threshold. The training further includes computing the loss associated with the generator of the second image prediction model. The training further includes determining the noise controlling parameter based on comparing the loss with the threshold loss. The training further includes iteratively training the second image generation model until the difference is reduced to generate a set of losses and their associated noise parameters as the noise training datasets.

In some embodiments, converting the vibration signal data to a first image includes segmenting the vibration signal data into multiple segments. The converting the vibration signal data to a first image further includes computing a Gram tensor for a first segment of the segments. The converting the vibration signal data to a first image further includes generating the first image based on the Gram tensor, where tensor values from the Gram tensor are mapped to pixel values of the first image.

In another exemplary embodiment, a non-transitory computer-readable storage medium for storing computer-readable instructions that, when executed by a computer, cause the computer to perform a method of training an image prediction model to generate training data for training a fault prediction model to predict a fault type of a bearing based on an image representative of characteristics of the bearing, is described. The method comprises obtaining multiple sets of data, wherein each set of data includes (a) noise image, (b) a ground-truth fault image representative of one of multiple types of a fault of a bearing in a machine, and (c) a fault type associated with the ground-truth fault image. Herein, the training includes training an image generation model using the sets of data to generate a specified fault image for a specified fault type. Further, herein, training the image generation model includes generating, using a generator of the image generation model, a predicted fault image based on the noise image and the fault type. The training the image generation model further includes determining, using a discriminator of the image generation model, whether a difference between the predicted fault image and the ground-truth fault image is less than a specified threshold. The training the image prediction model further includes iteratively training the image prediction model until the difference is reduced.

In some embodiments, the method of training the image generation model includes applying spectral normalization to adjust a Lipschitz constant of the discriminator.

In some embodiments, the method of training the image generation model includes determining, using a noise generator model, a noise controlling parameter, which is used to control amount of noise added to the noise image. The method of training the image generation model further includes modifying the noise image based on the noise controlling parameter to generate noisy image data. The method of training the image generation model further includes inputting the noisy image data to the generator to generate the predicted fault image.

In some embodiments, the method of determining the noise controlling parameter includes obtaining a loss associated with the generator during training of the image generation model. The loss is determined based on the PSNR values of the generated images obtained during the first training. The loss values of a range of training steps where the PSNR of the generated images increased were extracted and a mean of the corresponding loss values was used as a threshold for generating the controlling parameters. The method of determining the noise controlling parameter further includes determining, using the noise generator model, the noise controlling parameter based on the loss.

In some embodiments, the method further includes during an inference stage, inputting multiple noise images and associated fault types to the image prediction model, wherein each noise image is associated with one of the fault types. The method further includes executing the image prediction model to generate multiple fault images, wherein the fault images include one or more fault images for each of the fault types.

In some embodiments, the method further comprises training a fault prediction model with the fault images as training data to predict a fault type of the bearing for an input image. Herein, the training includes generating a feature vector combination from a first fault image of the fault images. The feature vector combination is a combination of (a) location-agnostic and channel-specific features and (b) location-specific and channel-agnostic features of the first fault image. The training further includes generating a predicted fault type associated with the first fault image based on the feature vector combination. The training further includes performing the training until a first loss function associated with the fault prediction model is reduced. Herein, the first loss function is indicative of a difference between ground-truth fault type associated with the first fault image and the predicted fault type.

In some embodiments, the method further comprises obtaining vibration signal data that is representative of characteristics of the bearing. The vibration signal data includes a one-dimensional time domain signal. The method further comprises converting the vibration signal data to a first image. The first image is a two-dimensional grayscale image representation of the vibration signal data. The method further comprises executing the fault prediction model by inputting the first image to determine a type of fault in the bearing. The executing includes extracting, using a feature extraction model, multiple feature vectors from the first image that are representative of the characteristics of the bearing. The feature vectors are extracted using location-agnostic convolution operation and location-specific involution operation. The executing further includes determining, by the fault prediction model, the type of fault in the bearing based on the feature vectors.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flowchart of a method of determining a type of fault of a bearing in a machine, according to certain embodiments.

FIG. 2 is an exemplary schematic diagram of a Generative Adversarial Network (GAN) architecture, according to certain embodiments.

FIG. 3 is an exemplary schematic diagram of a Class Conditional GAN (cGAN) architecture, according to certain embodiments.

FIG. 4 is an exemplary schematic diagram of an Adaptive Adversarial Class Conditional GAN (AAC-cGAN) architecture, according to certain embodiments.

FIG. 5 is an exemplary schematic diagram of an Adaptive Noise Generation (ANG) network, according to certain embodiments.

FIG. 6 is an exemplary flow diagram of adversarial noise injection process, according to certain embodiments.

FIG. 7 is an exemplary flow diagram depicting working principle of a discriminator in the AAC-cGAN architecture, according to certain embodiments.

FIG. 8 is an exemplary diagram of spectral normalization process, according to certain embodiments.

FIG. 9 is an exemplary schematic diagram of an architecture of a Convolutional Neural Network (CNN), according to certain embodiments.

FIG. 10 is an exemplary schematic diagram of an architecture of an Involutional Neural Network (i-NN), according to certain embodiments.

FIG. 11 is an exemplary schematic diagram of bearing fault classification scheme, according to certain embodiments.

FIG. 12 depicts channel-specific and spatial-agnostic feature extraction process by a convolution kernel, according to certain embodiments.

FIG. 13 depicts channel-agnostic and spatial-specific feature extraction process by an involution kernel, according to certain embodiments.

FIG. 14 is an exemplary illustration of a bearing fault acquisition setup, according to certain embodiments.

FIG. 15 illustrates a segmentation process of vibration signals, according to certain embodiments.

FIG. 16A is a graph of class distribution of imbalanced fault data for No-Load (N-L) condition, according to certain embodiments.

FIG. 16B is a graph of class distribution of imbalanced fault data for Single-Load (S-L) condition, according to certain embodiments.

FIG. 17 illustrates a process of converting 1-D time domain signals to 2-D grayscaled images, according to certain embodiments.

FIG. 18A is a graph of upsampling ratio of imbalanced classes for N-L condition, according to certain embodiments.

FIG. 18B is a graph of upsampling ratio of imbalanced classes for S-L condition, according to certain embodiments.

FIG. 19A is a chart of inception score, as evaluation metric, for cGAN and AAC-cGAN, according to certain embodiments.

FIG. 19B is a chart of Frechet inception distance, as evaluation metric, for cGAN and AAC-cGAN, according to certain embodiments.

FIG. 19C is a chart of learned perceptual image patch similarity, as evaluation metric, for cGAN and AAC-cGAN, according to certain embodiments.

FIG. 19D is a chart of mean squared error, as evaluation metric, for cGAN and AAC-cGAN, according to certain embodiments.

FIG. 20 is a graph of accuracy assessment for imbalanced datasets on custom and pre-trained networks, according to certain embodiments.

FIG. 21 is a graph of accuracy assessment for cGAN-based upsampling on custom and pre-trained networks, according to certain embodiments.

FIG. 22 is a graph of accuracy assessment for AAC-cGAN based upsampling on custom and pre-trained networks, according to certain embodiments.

FIG. 23A is a chart of accuracy curve of proposed and pre-trained models for accuracy values for N-L condition, according to certain embodiments.

FIG. 23B is a chart of accuracy curve of proposed and pre-trained models for accuracy values for S-L condition, according to certain embodiments.

FIG. 24 is an illustration of a non-limiting example of details of computing hardware used in a computer for determining a type of fault of a bearing in a machine, according to certain embodiments.

FIG. 25 is an exemplary schematic diagram of a data processing system used within the computer, according to certain embodiments.

FIG. 26 is an exemplary schematic diagram of a processor used with the computer, according to certain embodiments.

FIG. 27 is an illustration of a non-limiting example of distributed components which may share processing with the computer, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of this disclosure are directed to a method and system for bearing fault diagnosis. The present disclosure combines an Adaptive Adversarial Class-Conditional Generative Adversarial Network (AAC-cGAN) with a hybrid Involution-Convolution Feature Fusion Network (I-C FFN) to achieve superior fault detection and classification performance. The present disclosure effectively addresses the challenge of imbalanced datasets by generating high-quality synthetic samples. The feature extraction method combines the strengths of involution and convolution operations, capturing both spatial-specific and channel-specific features. Furthermore, the adaptive adversarial noise injection mechanism enhances the robustness of the model against potential adversarial attacks, making the present disclosure more reliable for industrial applications.

The disclosed embodiments include an image prediction model (or “image generation model”), such as the AAC-cGAN, to generate fault images representative of different types of faults in a bearing of a machine. The faut images may be used as training data for training a fault prediction model (e.g., a classification model) to predict a type of bearing fault for any given fault image. The AAC-cGAN architecture provides various advantages for bearing fault diagnosis. For example, by incorporating class label information in the prediction, cGANs can generate synthetic samples (e.g., fault images) for specific fault types, addressing the challenge of imbalanced datasets in bearing fault diagnosis. This controlled generation allows for the creation of additional samples for underrepresented fault classes, potentially improving the performance of fault classification models. In another example, by combining the elements of cGAN architecture and the AAC architecture, the quality and diversity of generated bearing fault samples are improved, potentially enhancing the performance of subsequent fault classification models. In some embodiments, the AAC architecture includes (i) a spectral normalization layer to ensure spectral stability (e.g., constrains the Lipschitz constant of the discriminator) to promote smooth training and resistance to exploding and vanishing gradients, and (ii) an adaptive noise generation (“ANG”) network that controls the amount of adversarial noise injected into a generated fault image sample. The AAC-cGAN effectively addresses two crucial issues that substantially affect the training and generation of quality samples: spectral stability and adversarial robustness.

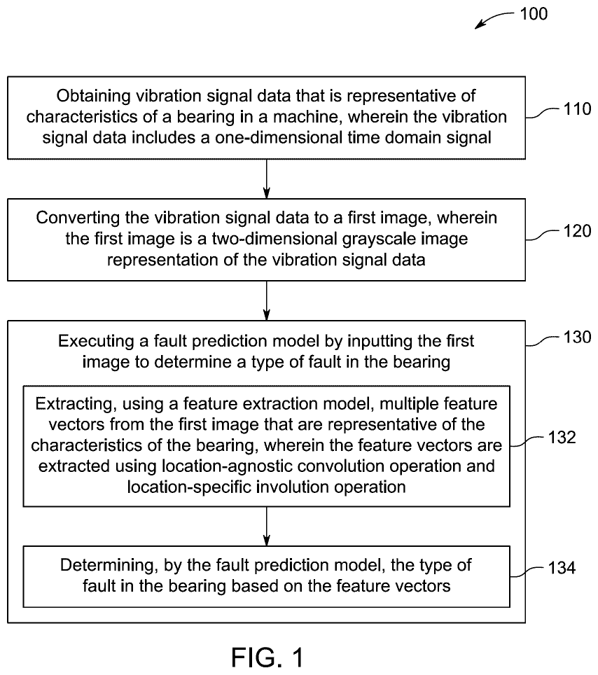

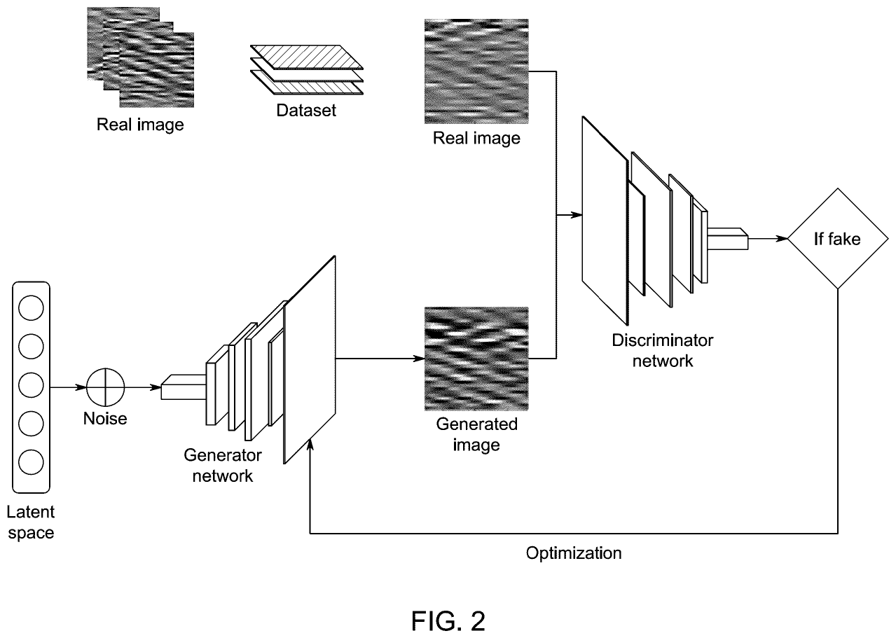

Referring to FIG. 1, illustrated is flowchart of a method (as represented by reference numeral 100) of determining a type of fault of a bearing in a machine. As used herein, a “bearing” refers to a mechanical component that constrains relative motion between moving parts to only the desired motion while reducing friction. A “machine” is a mechanical or electrical device with multiple components, including bearings, that performs a specific function or task, typically in an industrial setting. A “fault” is an abnormal condition or defect in the bearing that affects its performance, efficiency, or longevity, potentially leading to failure if left unaddressed. The method 100 utilizes advanced signal processing and machine learning techniques to analyze vibration data collected from the bearing. The method 100 transforms raw vibration signals into a two-dimensional (2D) image, converts the 2D images to a format suitable for deep learning analysis (e.g., up-sampled fault images), extracts relevant features using a novel combination of convolutional and involutional neural network architectures, and employs a trained classifier to identify and categorize different types of bearing faults. By using these advanced techniques, the method 100 aims to provide accurate and reliable fault diagnosis, even in scenarios with imbalanced datasets or limited fault samples. This approach enables early detection of bearing faults, potentially reducing downtime, preventing catastrophic failures, and improving overall machine reliability in industrial applications. The method 100 utilizes multiple components and techniques preferably in combination for determining a type of fault of a bearing in a machine, as discussed in reference to FIGS. 2-10 in the proceeding paragraphs.

FIG. 2 illustrates an exemplary schematic diagram of a Generative Adversarial Network (GAN) architecture, which plays a role in addressing the challenge of imbalanced datasets in bearing fault diagnosis. As shown, the GAN architecture includes two main components: a generator and a discriminator. The generator is designed to create synthetic data samples, while the discriminator aims to distinguish between real and generated samples. In the context of bearing fault diagnosis, the generator attempts to produce synthetic vibration signal data that mimics characteristics of real bearing faults. The GAN architecture, in FIG. 2, shows the generator receiving an input of random noise, typically drawn from a simple distribution such as Gaussian noise. The generator processes this noise through its neural network layers to produce synthetic data samples. These generated samples are then fed into the discriminator along with real data samples from the training dataset. The discriminator, also implemented as a neural network, takes both real and generated samples as input and attempts to classify them as either real or fake. The output of the discriminator represents the probability that the input sample is real rather than generated.

The training process of the GAN involves an adversarial game between the generator and the discriminator. The generator aims to produce samples that are increasingly difficult for the discriminator to distinguish from real samples, while the discriminator strives to improve its ability to correctly classify real and generated samples. Mathematically, this adversarial process can be expressed as a min-max game:

$${min}_{G} , {max}_{D} {E}_{x ∼ D} [ log ( D ( x ) ) ] + {E}_{z ∼ Noise} [ log ( 1 - D ( G ( z ) ) ] \qquad ( 1 )$$

where, G represents the generator, D represents the discriminator, x represents real data samples, z represents random noise input to the generator, x˜D is the real data distribution, and z˜Noise is the noise distribution.

The GAN training procedure is carried out iteratively until the generator produces samples that closely mimic the distribution of the real dataset, making it difficult for the discriminator to effectively distinguish between real and generated samples. This equilibrium state results in the generator creating synthetic data samples that approximate the characteristics of the original bearing fault dataset. The GAN architecture, illustrated in FIG. 2, serves as a foundation for more advanced GAN variants used in the present invention, such as the Adaptive Adversarial Class-Conditional GAN (AAC-cGAN) discussed later, which incorporates additional techniques to enhance the quality and diversity of generated bearing fault samples.

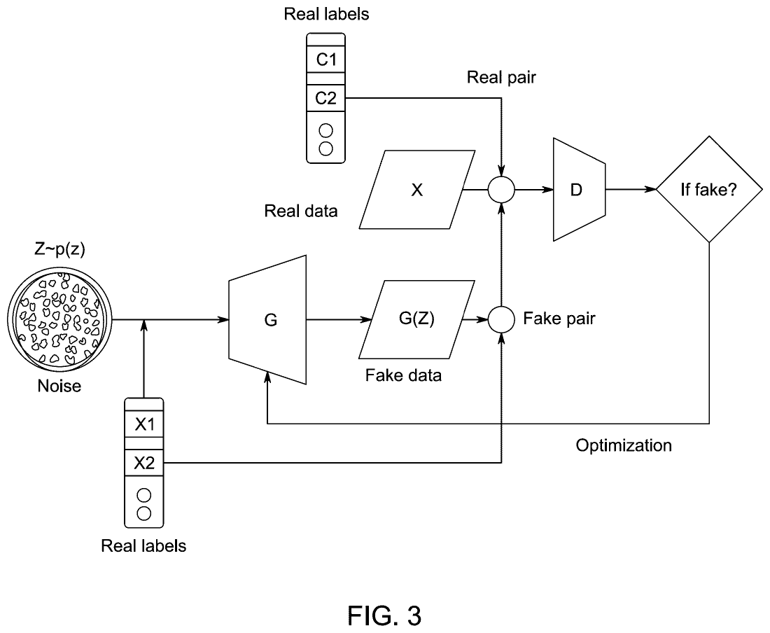

Referring to FIG. 3, illustrated is an exemplary schematic diagram of a Class Conditional GAN (cGAN) architecture. The cGAN represents an advancement over traditional GANs, specifically designed to enable controlled generation of samples based on class labels. Unlike standard GANs, cGANs take additional information, often class labels, as input during the training process. The generator in the cGAN takes two inputs: random noise (z) and a class label (y). The random noise provides the variability necessary for diverse sample generation, while the class label guides the generator to produce samples of a specific class. The generator processes these inputs through its neural network layers to create synthetic samples G(z|y) that correspond to the given class label. The discriminator in the cGAN also receives two inputs: either a real sample (x) and a generated sample G(z|y), along with the corresponding class label (y). The discriminator is configured to determine whether the generated sample is real or fake (e.g., by determining a difference between both the real sample and the generated sample), while also considering the class label information. This allows the discriminator to assess not only the realism of the generated sample but also its correspondence to the given class.

The objective function for cGANs combines the standard GAN objective with an additional conditioning term. Mathematically, this can be expressed as:

$${min}_{G} {max}_{D} {𝔼}_{x ∼ {p}_{data} ( x \vert y )} [ log D ( x \vert y ) ] + {𝔼}_{z ∼ {p}_{z} ( z ) , y} [ log ( 1 - D ( G ( z \vert y ) \vert y ) ) ] \qquad ( 2 )$$

where, x represents real image, G(z|y) represents a fake image (e.g., generated by the generator) with label y, and D(x|y) represents the probability value of discriminator that the generated image is real.

The cGAN architecture provides several advantages for bearing fault diagnosis. By incorporating class label information, cGANs can generate synthetic samples for specific fault types, addressing the challenge of imbalanced datasets in bearing fault diagnosis. This controlled generation allows for the creation of additional samples for underrepresented fault classes, potentially improving the performance of fault classification models. However, cGANs, like traditional GANs, can still face challenges such as mode collapse, where the generator produces limited varieties of samples, and training instability. Additionally, deep learning models, including GANs, are susceptible to adversarial attacks due to their dependence on learned parameters. Adversarial attacks can cause misclassification, which can prove critical in applications like machinery monitoring, where misclassifications can result in safety risks. To address these issues and further improve the quality and diversity of generated bearing fault samples, the present disclosure introduces additional techniques in the form of the AAC-cGAN, as discussed in proceeding paragraphs.

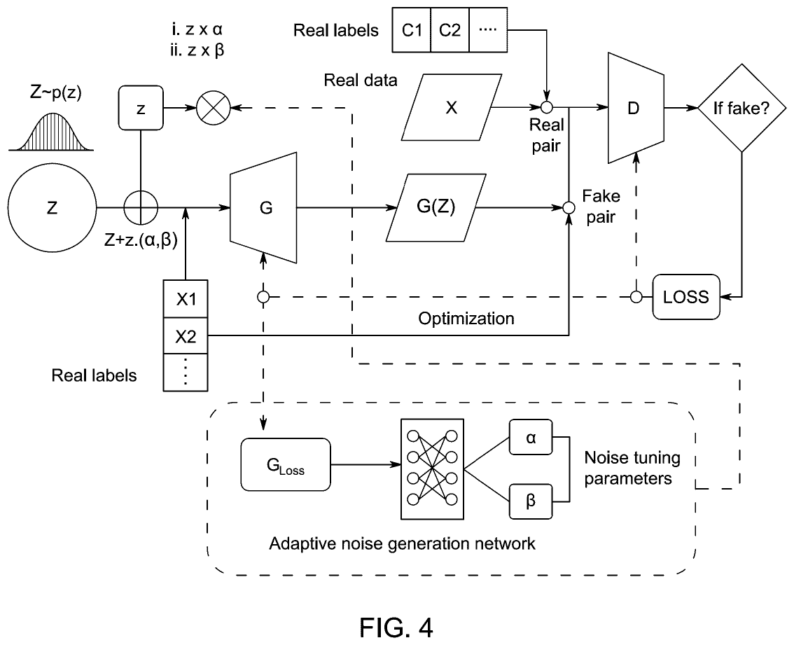

Referring to FIG. 4, illustrated is an exemplary schematic diagram of the AAC-cGAN architecture, which represents a generative framework tailored for the synthesis of bearing fault signals. The AAC-cGAN builds upon the foundational principles of cGANs while introducing key enhancements to address issues in sample generation and model training. The AAC-cGAN architecture includes several components: a generator, a discriminator, a spectral normalization layer, and an adaptive noise generation network. The generator and discriminator are conditioned on particular class labels, allowing for the generation of data belonging to specific fault classes or fault types. The generator takes random noise Z and a class label y as input and generates samples G(z, y). The spectral normalization layer, in the discriminator section, ensures spectral stability which promotes smooth training and resistance to exploding and vanishing gradients. The spectral normalization technique constrains the Lipschitz constant of the discriminator, thereby stabilizing the training process. The adaptive noise generation network controls the amount of adversarial noise injected into the generator as part of a training regimen. The adaptive noise generation network is trained separately on the generator loss accumulated by a baseline GAN network, and is then integrated into the AAC-cGAN training loop to generate noise controlling parameters (α and β) by passing the GAN Loss as input to the trained Adaptive Noise Generation Network (ANG).

By combining these elements, the AAC-cGAN effectively addresses two crucial issues that substantially affect the training and generation of quality samples: spectral stability and adversarial robustness. This architecture aims to improve the quality and diversity of generated bearing fault samples, potentially enhancing the performance of subsequent fault classification models. The general implementation of the AAC-cGAN architecture, as shown in FIG. 4, provides a framework for generating synthetic bearing fault signals (e.g., “fault image” representative of fault signal for a particular fault type). This approach has the potential to address the challenge of imbalanced datasets in bearing fault diagnosis by generating additional samples for underrepresented fault classes, while also improving the robustness and stability of the generative process.

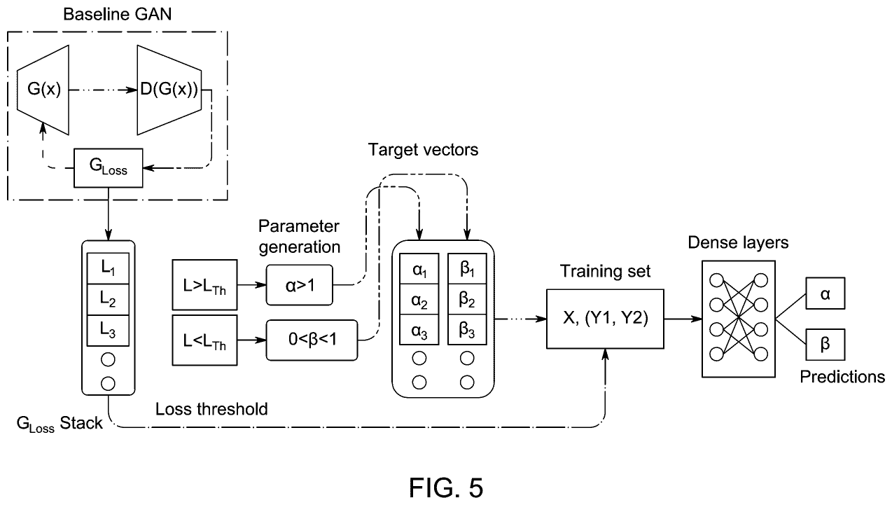

FIG. 5 illustrates an exemplary schematic diagram of an Adaptive Noise Generation (ANG) network, a key component of the AAC-cGAN architecture. The ANG network is designed to dynamically generate noise adjustment factors (α and β) based on the current value of the Generator Loss (G_{Loss}) during training. As depicted in FIG. 5, the ANG network consists of a feed-forward neural network with one or more dense layers. The input to the ANG network is G_{Loss}, which is extracted each epoch from a baseline GAN trained on the respective experimental data. The output of the network is the noise adjustment factors α and β. The ANG network operates based on a threshold L_{Th}, which is manually selected from the acquired G_{Loss} stack. The generation of α and β target variables is done using the following constraints:

$${G}_{L o s s} \geq {L}_{T h} \qquad ( 3 )$$

Increase the magnitude of adversarial noise.

$${Z}_{noisy} = Z + z \cdot α \vert α > 1 \qquad ( 4 )$$

$$If ,$$

$${G}_{L o s s} \leq {L}_{T h} \qquad ( 5 )$$

Decrease the magnitude to avoid over-regularization.

$${Z}_{noisy} = Z + n \cdot β \vert 0 < β < 1 \qquad ( 6 )$$

wherein, the variables Z, z and n represent different components of the noise injection process in the GAN framework. In particular, the Z variable represents the latent noise vector that is fed into the GAN network as part of the sample generation process. It serves as the initial random input that the generator transforms into synthetic data samples. The z variable denotes the noise component that has been scaled up by the factor α. Specifically, z=α*Z, where α is greater than 1. This scaled-up noise introduces higher variability into the generated samples, aiding the generator in learning a broader range of features. The n variable signifies the noise component that has been scaled down by the factor β. Specifically, n=β*Z, where β is less than 1. This scaled-down noise introduces a subtler variation into the generated samples, which can help the generator refine its outputs by reducing the intensity of the added noise.

Herein, the ANG network generates a single regression value based on the Generator's loss. The model's output is notated as α or β based on the threshold of the generator's loss. For instance, if the generator's loss is greater than the set threshold the output from the ANG network will be α while for the G_{Loss}<Threshold the output generated will be β. The ground truths for noise adjustment values (α and β) are generated based on the generator's loss for the training of ANG network. Both the α and β values are generated randomly within a specified range in accordance with the respective loss value threshold. The values for β are within the range (0-1) while the values of α are >1 (within finite range) depending upon the problem; as for the present case, α is selected between the range (1-2). These adjustment parameters can be thought of as scaling factors for the added noise. The random generation of these adjustment parameters was intended to learn an increased number of solutions and introduce variability, which is essential for the generator in initial stages of training.

The optimal threshold for G_{Loss} is estimated by analyzing the Peak Signal to Noise Ratio (PSNR) for each epoch against the G_{Loss} value. The trends are observed for the baseline GAN model and G_{Loss} values are extracted for only those ranges where the G_{Loss} is stable and the PSNR value is increasing. Then the mean loss value is computed from the selected G_{Loss} values and considered as threshold. It is also crucial to train the baseline GAN model for longer steps and epochs to get a sizeable G_{Loss} chunk for the auxiliary model training and to get a better indication of PSNR trends.

In present implementations, for any given instance of G_{Loss}, either α or β is computed and added to the random image data to generate Z_{noisy}, but not both simultaneously. The ANG network predicts a single adjustment parameter based on the threshold G_{Loss} value. If G_{Loss} exceeds the threshold, α is used to scale the noise added to the random image data, resulting in Z_{noisy}. Conversely, if G_{Loss} is below the threshold, β is utilized to scale the noise. This selective application ensures that the noise introduced into the generator's input is appropriately modulated based on the generator's performance, promoting better training dynamics and sample generation quality.

After the generation of target labels and creating a training set, the corresponding features and target variables are fed to the feed-forward network given as under.

$$InputLayer ⇒ [ {G}_{L o s s} ] \qquad ( 7 )$$

$$Hidden Layer ⇒ {H}_{i} = σ ( {W}_{i} \cdot {H}_{i - 1} + {b}_{i} ) \qquad ( 8 )$$

$$Output {Layer}_{α} ⇒ σ ( {W}_{α} * {H}_{n} + {b}_{α} ) \qquad ( 9 )$$

$$Output {Layer}_{β} ⇒ σ ( {W}_{β} * {H}_{n} + {b}_{β} ) \qquad ( 10 )$$

where, G_{Loss} represents Generator Loss, i represents layer number, a represents activation function (e.g., ReLU or Sigmoid), Wᵢ and bᵢ represent weight and bias for i^{th} layer, and W_{α}, W_{β}, b_{α}, and b_{β} are weight matrices and bias for the output layer.

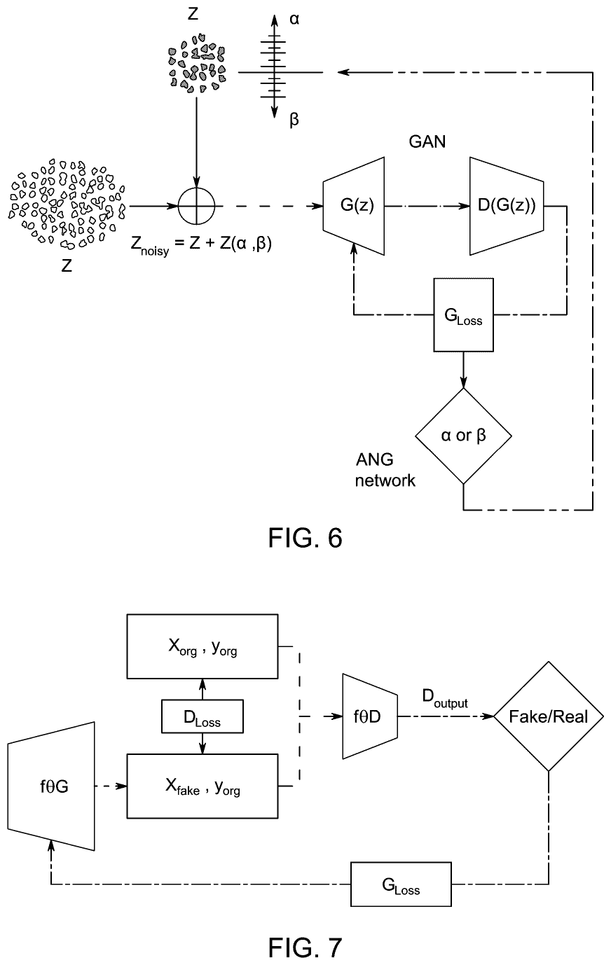

FIG. 6 is an exemplary flow diagram of adversarial noise injection process. The controlled noise Z_{noisy} generated by the ANG network is then injected into the generator's input as:

$${H}_{o} = Dense ( {Z}_{noisy} ) \qquad ( 11 )$$

where, Hₒ is the output of the dense layer that takes the noisy input Z_{noisy}.

The generator processes the noisy input Z_{noisy} and produces a synthetic sample X_{fake} such that,

$${X}_{fake} = f θ G ( {Z}_{n oisy} , y ) \qquad ( 12 )$$

where, X_{fake} represents generated synthetic sample, f θ G represents generator function, Z_{noisy} represents noisy input, and y represents class label.

FIG. 7 is an exemplary flow diagram depicting working principle of a discriminator in the AAC-cGAN architecture. The discriminator evaluates the authenticity of X_{fake} by considering both the class label y and the presence of added noise. Its output Dₒᵤₜₚᵤₜ indicates the prediction of the input resembling a real sample.

$${D}_{output} = f θ D ( {X}_{fake} , y ) \qquad ( 13 )$$

where, Dₒᵤₜₚᵤₜ represents discriminator's output, f θ D represents discriminator function, X_{fake} represents generated synthetic sample, and y represents class label.

This adaptive noise injection mechanism enables the AAC-cGAN to control the magnitude and type of adversarial noise introduced into the generator's input dynamically, potentially leading to improved quality and diversity of generated bearing fault samples.

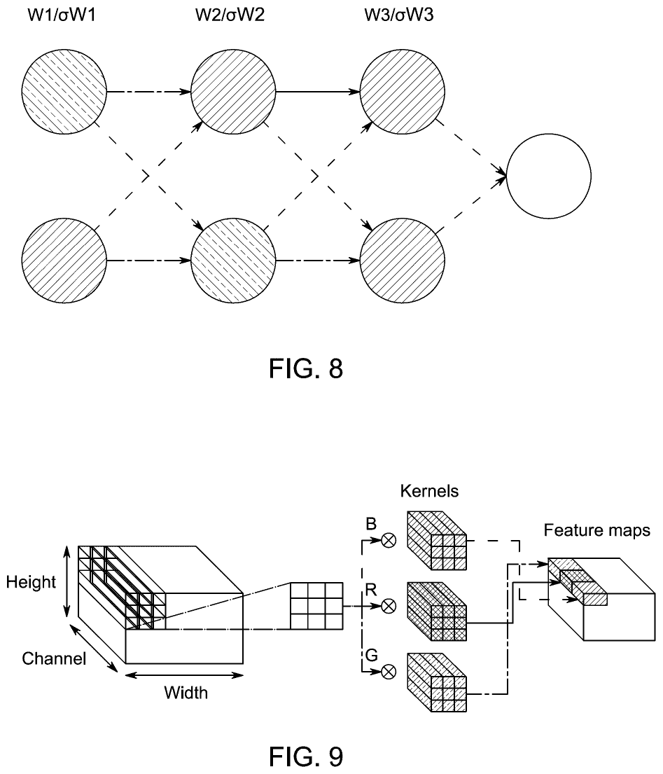

FIG. 8 illustrates the exemplary diagram of the spectral normalization process. Spectral normalization is a technique used to constrain the Lipschitz constant of neural networks in order to enhance training stability. In the AAC-cGAN architecture, weight matrices W of the discriminator are stabilized by applying spectral normalization, further ensuring that the Lipschitz constant of these networks does not exceed a specified threshold. The spectral normalization process can be mathematically represented as:

$$\tilde{W} = \frac{σ ( W )}{W} \qquad ( 14 )$$

where, \tilde{W} represents spectrally normalized weight matrix, W represents original weight matrix, and σ (W) represents largest singular value of W.

FIG. 9 depicts an exemplary schematic diagram of the architecture of a Convolutional Neural Network (CNN). In traditional CNNs, convolution is performed on a data tensor D of shape (n, C, H, W), where n represents the number of samples, C is the number of channels, and H and W are the spatial dimensions. Convolutional filters (also known as kernels) are applied to the input data, with each filter having weights shared across all spatial positions. Mathematically, the output K for a single filter can be represented as:

$${C}_{i} = {\sum }_{j = 1}^{N} {( F \cdot {K}_{i} )}_{j} \qquad ( 15 )$$

where, Cᵢ represents output features of i^{th} convolutional layer, N represents filter count, F represents feature map obtained from involutions, and Kᵢ represents i^{th} convolutional kernel.

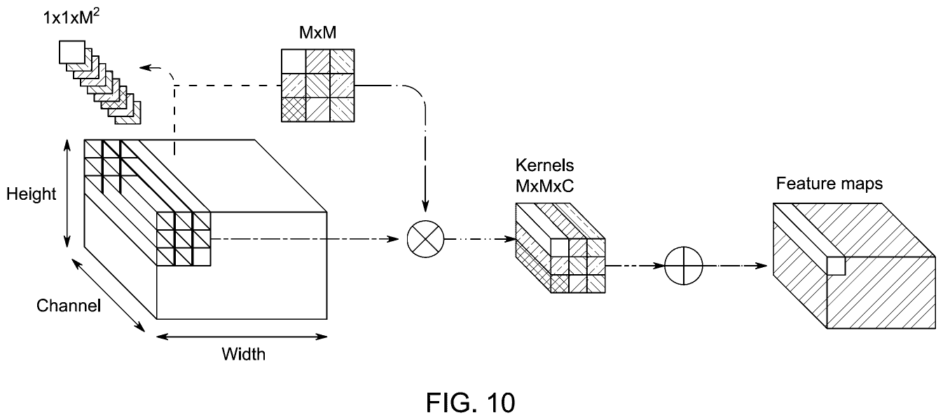

FIG. 10 illustrates an exemplary schematic diagram of the architecture of an Involutional Neural Network (i-NN). The i-NNs are a neural network architecture for computer vision tasks. They introduce “involution,” an operation that adaptively combines input values using learned parameters associated with specific positions in the input, enhancing spatial sensitivity. The i-NNs challenge traditional convolutional design principles, achieving improved performance in tasks like image classification and object detection while often reducing computational costs. This approach bridges convolution and self-attention mechanisms, making it a tool for efficient and effective deep learning in visual recognition. Involution aims to invert the design principles of convolution, making it more location-sensitive and channel-agnostic. In an involutional layer, instead of using shared weights for all spatial positions, distinct weights are used for different spatial positions. Mathematically, the output P for a single position (i, j) can be represented as:

$${p}_{val} = {x}_{i} + m - ⌊ \frac{{K}_{size}}{2} ⌋ , j + n - ⌊ \frac{{K}_{size}}{2} ⌋ , c \qquad ( 16 )$$

$${P}_{i , j} = {\sum }_{m = 1}^{K} {\sum }_{n = 1}^{K} {K}_{m , n} \cdot {p}_{val} \qquad ( 17 )$$

where, P_{i,j} is the output at position (i,j) in the feature map for channel c, K_{m,n} is the input value at position m, pᵥₒₗ is pixel values from the input image at shifted positions based on kernel size for channel c, and K is the size of the filter.

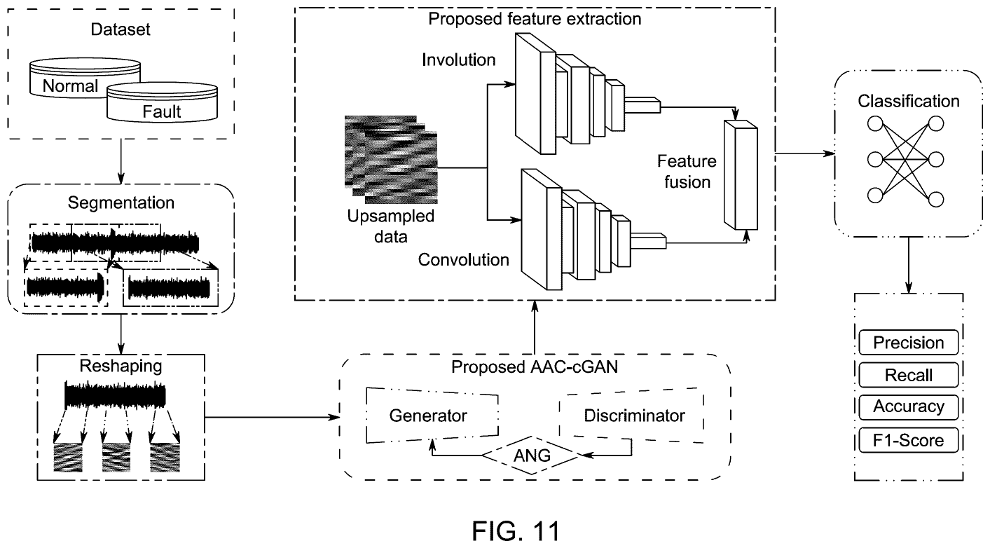

Referring now to FIG. 11, illustrated is an exemplary schematic diagram of a bearing fault classification scheme, which executes the method 100 (as depicted in FIG. 1) of determining a type of fault of a bearing in a machine. As shown in FIG. 1, at step 110, the method 100 includes obtaining vibration signal data that is representative of characteristics of a bearing in a machine. This process is depicted in the “Dataset” section of FIG. 11. Herein, the vibration signal data includes a one-dimensional time domain signal. The vibration signal data is typically acquired using sensors, such as accelerometers, attached to the housing of the machine containing the bearing. The data acquisition process may involve rotating the bearings at distinct speeds and under various operating conditions to capture signal details that represent different states of bearing health. The vibration signals are collected as time-series data, representing the amplitude of vibrations over time. This one-dimensional time domain signal contains information about condition of the bearing, including potential fault signatures. The sampling rate for data acquisition is typically set at a high frequency, such as 12,000 samples per second or 48,000 samples per second, to capture high-frequency components that may be indicative of bearing faults. The vibration signal data may be collected for various types of bearings, such as deep groove ball bearings, and under different load conditions, including no-load and single-load scenarios.

At step 120 of FIG. 1, the method 100 includes converting the vibration signal data to a first image. Herein, the first image is a two-dimensional grayscale image representation of the vibration signal data. This conversion process involves several steps to transform the one-dimensional time domain signal into a format suitable for advanced image processing techniques. The method 100 implements the “Segmentation” step shown in FIG. 11 for this purpose. Here, the one-dimensional time domain signal is divided into multiple segments. This segmentation process helps in capturing local patterns and temporal dependencies within the vibration data. Following segmentation, the method 100 moves to the “Reshaping” step illustrated in FIG. 11. The reshaping process transforms the segmented one-dimensional signals into two-dimensional matrices, which can be interpreted as grayscale images. This conversion allows the subsequent steps to leverage image processing techniques for feature extraction and classification.

In present embodiments, converting the vibration signal data to a first image includes multiple sub-steps. First, the method 100 involves segmenting the vibration signal data into multiple segments. That is, the one-dimensional time domain signal is segmented into multiple segments. In one embodiment, a window size of 1024 samples with a stride size of 500 samples is used for segmentation. This stride size ensures that the correlation and patterns between successive segments are captured. The segmentation process helps in preserving local temporal information within the signal. Then, the method 100 involves computing a Gram tensor for a first segment of the segments. The Gram tensor is derived by computing the outer product of the windowed signal with itself, resulting in a matrix that encapsulates the energy and correlation information within the segment. The Gram tensor effectively captures the intricate vibrational patterns and temporal dependencies present in the signal, offering a richer representation than the original one-dimensional data. The method 100, then, involves generating the first image based on the Gram tensor, where tensor values from the Gram tensor are mapped to pixel values of the first image. For this purpose, the Gram tensor is normalized and scaled to fit within a grayscale intensity range. This normalized tensor is reshaped into a two-dimensional matrix, typically of size 32×32, where the tensor values are mapped to pixel intensities. The resulting grayscale image visually represents the complex vibrational characteristics of the original signal.

This conversion process allows the method 100 to leverage the spatial feature extraction capabilities of convolutional and attention-based neural networks, which are typically designed for image data. The two-dimensional grayscale image representation retains the essential temporal and frequency information of the original vibration signal while presenting it in a format that can be efficiently processed by advanced machine learning algorithms. The conversion of vibration signal data to a two-dimensional grayscale image enables the application of various image processing and deep learning techniques for fault feature extraction and classification, potentially improving the accuracy and robustness of the bearing fault diagnosis process.

At step 130 of FIG. 1, the method 100 includes executing a fault prediction model by inputting a first image (e.g., a fault image such as a 2D grayscale image generated by converting the vibration signal data of a bearing) to determine a type of fault in the bearing. This execution involves two main sub-steps: feature extraction and fault type determination, as illustrated in “Proposed Feature Extraction” and “Classification” blocks of FIG. 11. As shown, the “Proposed Feature Extraction” block represents a feature extraction method that combines Involution and Convolution operations. In particular, at step 132 of FIG. 1, the method 100 includes extracting, using a feature extraction model, multiple feature vectors from the first image that are representative of the characteristics of the bearing. Herein, the feature vectors are extracted using location-agnostic convolution operation and location-specific involution operation. That is, the feature extraction step uses a feature extraction model to extract multiple feature vectors from the first image that are representative of the characteristics of the bearing. This extraction process employs a combination of location-agnostic convolution operations and location-specific involution operations, as depicted in the parallel “Involution” and “Convolution” branches in FIG. 11. The “Involution” branch captures location/spatial-specific and channel-agnostic features, while the “Convolution” branch extracts channel-specific and location/spatial-agnostic features.

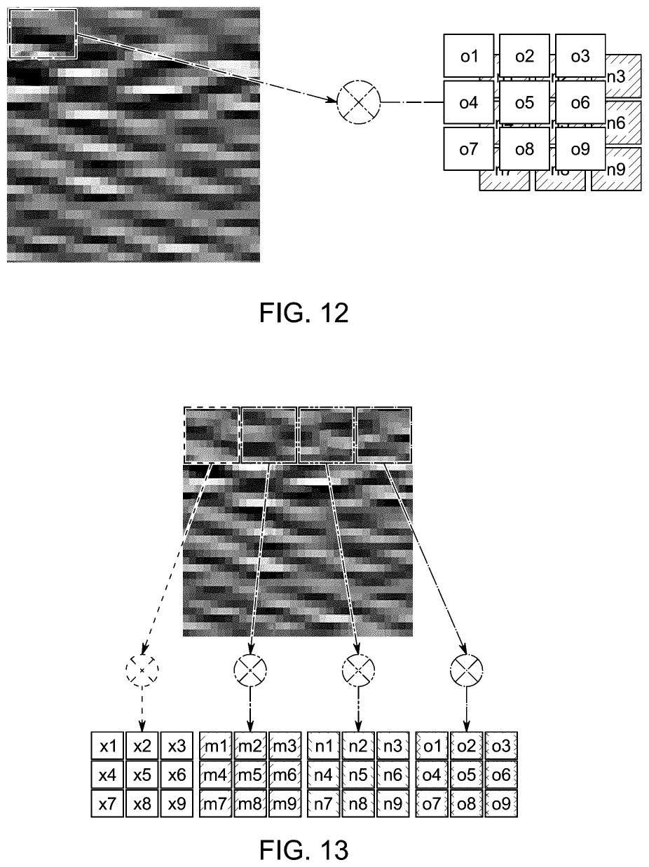

More specifically, extracting the feature vectors includes multiple steps. Herein, the method 100 involves performing a convolution operation on the first image to obtain a first set of feature vectors that have location-agnostic and channel-specific features of the first image. The convolution operation, illustrated in FIG. 12, is performed on the first image to obtain the first set of feature vectors that have location-agnostic and channel-specific features. In this process, convolutional filters slide over the input image, computing weighted sums of local patches. This operation captures global details and is channel-specific, applying computationally expensive matrix operations with varying weighted kernels for each channel to acquire color details.

The convolution section of the proposed feature extraction pipeline is based on multi-layered feature extraction. With multiple kernels that slide over the feature map F, computing a weighted sum of local patches, global details are extracted. While the channel specific approach, applied computationally expensive matrix operation of varying weighted kernel with each channel to acquire color details. These global details were made available to the classification network for fault diagnosis. Mathematically, a convolution operation can be represented as:

$${C}_{i} = {\sum }_{j = 1}^{N} {( F \cdot {K}_{i} )}_{j} \qquad ( 18 )$$

where, Cᵢ represents output feature map of the i^{th} convolutional layer, and N represents number of filters.

The convolution layers in the proposed I-C FFN architecture are fundamental for extracting global features from input images. These layers are meticulously configured with specific parameters to effectively capture channel specific and global aspects of the data. In the first Convolution Layer, a filter size of 3×5 is employed with ‘same’ padding, while the second layer uses a 3×7 filter with the same padding option. Both of these layers consist of 36 filters. A 2×2 max-pooling operation follows to down-sample the feature maps. The third Convolution Layer utilizes a 1×5 filter with ‘same’ padding, and the fourth layer employs a 3×5 filter with the same padding. These layers also consist of 36 filters each. Another 2×2 max-pooling layer follows these Convolution Layers. Additionally, the fifth and sixth Convolution Layers apply filters with sizes 3×7 and 3×9, both using ‘same’ padding and consisting of 36 filters each. These layers collectively contribute to a rich feature representation, as required for the architecture's success in tasks such as multi-class classification and feature extraction from bearing fault signals.

The method 100 further involves performing an involution operation on the first image to obtain a second set of feature vectors that have location-specific and channel-agnostic features of the first image. That is, simultaneously, an involution operation, shown in FIG. 13, is performed on the first image to obtain a second set of feature vectors that have location-specific and channel-agnostic features. The involution operation uses distinct weights for different spatial positions, allowing it to capture spatial dependencies effectively. This approach is particularly implemented for recognizing complex patterns in a channel-agnostic manner, which is beneficial for processing the single-channeled grayscale images of bearing faults.

Herein, for each element x(i, j) in the input matrix X, the proposed involution network compute a weighted sum of the surrounding elements, allowing for the incorporation of local information. The involution kernels move around each spatial location (xi+k, j+l) with different weights, capturing the local context and extracting the most informative region by utilizing self-attention. While doing so the same weights in a kernel are applied to each channel within the receptive field, resulting in a low computation matrix operation and a channel agnostic approach. This approach proves effective in dealing with single channeled images, where color channels hold very little information like the bearing fault gray-scaled images used in this study. This operation is given as:

$$y ( i , j ) = {\sum }_{k = 1}^{K} {w}_{k} \cdot {x}_{i + k , j + l} \qquad ( 19 )$$

where, y(i, j) is the output at position (i, j), K is the kernel size which defines the size of the local receptive field, wₖ represents the weights applied to the neighboring elements, and x_{i=k,j+l} represents the neighboring elements around (i, j).

Involutions are performed across the entire input matrix, resulting in a feature map F that retains important local patterns. The architecture begins with input images of size 32×32 with 3 channels, typical for color images. It employs a series of Involution Layers, each with distinct configurations. The Involution Layers capture spatial dependencies effectively. The first Involution Layer (“inv₁”) applies a 5×5 kernel with a group number of 3, reducing the spatial dimensions slightly. Next is the ReLU activation and max-pool to down-sample the feature maps. Subsequent Involution Layers (“inv₂”, “inv₅”, “inv₆”, and “inv₇”) follow similar patterns, further refining spatial relationships and features. These layers utilize different kernel sizes, striving to capture patterns at various scales. Finally, a max-pool layer is applied to down-size the feature map.

The method 100, then, involves concatenating the first set of feature vectors and the second set of feature vectors to generate a concatenated set of feature vectors, which is used as an input to the fault prediction model to determine the type of fault. That is, the features extracted by the convolution and involution operations are then concatenated to form a final feature vector, as represented by the “Feature Fusion” block in FIG. 11. This concatenation combines the strengths of both operations, providing the fault prediction model with a comprehensive set of features that capture both local and global information from the input image. The feature fusion of convolution and involution layers allows the network to benefit from the unique advantages of each operation. As discussed above, the Involution captures spatial dependencies effectively and operates in a channel-agnostic manner, rendering it adept at recognizing complex patterns. On the other hand, Convolution is proficient at detecting basic features and structures in a global feature extraction approach. The features of both these layers are concatenated to form a final feature vector, arming the model with holistic understanding of the input data, combining fine-grained details captured by Involution with broader context revealed by Convolution. This synergy enhanced ability of the network to extract discriminative features, making it a powerful tool for the required, gray-scaled images.

The feature concatenation operation between the output of the Involution Layers (denoted as Yᵢₙᵥ) and the output of Convolutional Layers (denoted as Y_{conv}) can be represented mathematically as follows: Yᵢₙᵥ is of shape H×W×Cᵢₙᵥ, where Cᵢₙᵥ is the number of channels after the Involution Layer. Y_{conv} is of shape H×W×C_{conv}, where C_{conv} is the number of channels after the Convolutional Layer. The feature concatenation operation can be represented as:

$${Y}_{concat} = c o n c at ( {Y}_{inv} , {Y}_{conv} ) \qquad ( 20 )$$

where, Y_{concat} is concatenated feature map, and Concat is concatenation two feature maps along the channel dimension. Table 1 below provides layer description for proposed I-C FNN feature extraction methodology.

TABLE 1
Layer description for proposed I-C FNN feature extraction methodology

| | | | Group | Kernel | | # of |
|---|---|---|---|---|---|---|
| Layer | Description | Channel | Number | Size | Stride | Layers |
| Input | Input layer | 3 | — | — | — | 1 |
| Involution 1 | Involution layer | 3 | 3 | 5 | 1 | 2 |
| Activation | ReLU | 3 | — | — | — | 3 |
| MaxPooling2D | MaxPooling2D | 3 | — | — | — | 4 |
| Involution 2 | Involution layer | 3 | 3 | 3 | 1 | 5 |
| Activation | ReLU | 3 | — | — | — | 6 |
| Dropout | Dropout = 0.2 | 3 | — | — | — | 7 |
| Involution 5 | Involution layer | 3 | 3 | 3 | 1 | 8 |
| Involution 6 | Involution layer | 3 | 3 | 5 | 1 | 9 |
| Involution 7 | Involution layer | 3 | 1 | 5 | 1 | 10 |
| MaxPooling2D | MaxPooling2D | 3 | — | — | — | 11 |
| Conv2D | filters = 36, kernel = (3, 5), | 36 | — | (3, 5) | — | 12 |
| | padding = ‘same’ | | | | | |
| Conv2D | filters = 36, kernel = (3, 7), | 36 | — | (3, 7) | — | 13 |
| | padding = ‘same’ | | | | | |
| MaxPooling2D | MaxPooling2D | 36 | — | — | — | 14 |
| Conv2D | filters = 36, size = (1, 5), | 36 | — | (1, 5) | — | 15 |
| | padding = ‘same’ | | | | | |
| Conv2D | filters = 36, size = (3, 5), | 36 | — | (3, 5) | — | 16 |
| | padding = ‘same’ | | | | | |
| MaxPooling2D | MaxPooling2D | 36 | — | — | — | 17 |
| Conv2D | filters = 36, size = (3, 7), | 36 | — | (3, 7) | — | 18 |
| | padding = ‘same’ | | | | | |
| Conv2D | filters = 36, size = (3, 9), | 36 | — | (3, 9) | — | 19 |
| | padding = ‘same’ | | | | | |
| Concatenation | Concatenation | — | — | — | — | 20 |
| Activation | ReLU | — | — | — | — | 21 |
| Global Avg. | — | — | — | — | — | 22 |
| Pool | | | | | | |
| Dense | Dense layer with units = | 99 | — | — | — | 23 |
| | 99, activation = “relu” | | | | | |
| Dense | Dense layer with units = | 23 | — | — | — | 24 |
| | 23, activation = “relu” | | | | | |
| Dense | Dense layer with units = | 14 | — | — | — | 25 |
| | 14, activation = “softmax” | | | | | |
| Output | Output layer | — | — | — | — | 26 |

Finally, at step 134, the method 100 includes determining, by the fault prediction model, the type of fault in the bearing based on the feature vectors. That is, the fault prediction model then uses this concatenated set of feature vectors as input to determine the type of fault in the bearing. This determination step is represented by the “Classification” block in FIG. 11. In present implementations, the classification model employed for classifying fault types based on features extracted from the up-sampled images is a Dense Neural Network (DNN) with a softmax classifier. This DNN is composed of multiple fully connected layers that are responsible for learning complex representations of the input features. The final layer of the network utilizes a softmax activation function, which converts the network's raw output scores into probability distributions over the predefined fault classes. This probabilistic interpretation allows the model to output the likelihood of each fault type, facilitating precise classification.

The classification model is trained to distinguish between different types of bearing faults as well as normal operating conditions. The optimization and training process involves back-propagation and gradient descent algorithms, ensuring that the model's parameters are fine-tuned to minimize the classification error over the training dataset. Such fault prediction model, which may be implemented as a neural network or other machine learning algorithm, processes the feature vectors to classify the input image into one of several predefined fault categories or as a normal operating condition. In some examples, the performance of the fault classification is evaluated using various metrics, as shown in FIG. 11. These metrics include Precision, Recall, Accuracy, and F1-Score, which provide a comprehensive assessment of performance of the classification model in determining the type of fault in the bearing. The implementation of such metrics may be contemplated by a person skilled in the art and thus not discussed herein in detail for brevity of the present disclosure.

While the method 100 (as described in the preceding paragraphs) provides an approach for bearing fault diagnosis using advanced feature extraction techniques, there are several challenges in real-world applications that necessitate further enhancements. These challenges include the scarcity of fault data, imbalanced datasets, and the need for more diverse and realistic fault samples for training. Additionally, the performance and stability of the fault prediction model can be further improved. To address these issues, the present disclosure incorporates several advanced techniques and optimizations. These include the use of generative models to create synthetic fault images, adaptive noise injection mechanisms to enhance the quality and diversity of generated samples, and training procedures for both the image prediction and fault prediction models. These additional embodiments aim to improve the overall accuracy, robustness, and generalization capabilities of the bearing fault diagnosis, particularly in scenarios with limited or imbalanced data.

In an embodiment, the method 100 includes obtaining, using an image prediction model, multiple fault images from noise data. This image prediction model is based on the AAC-cGAN architecture described at least with reference to FIGS. 4-6. The AAC-cGAN is designed (e.g., trained) to generate high-quality synthetic samples of bearing fault signals while addressing challenges such as spectral stability and adversarial robustness. For example, the generator in the AAC-cGAN takes random noise Z and a class label y as input and generates samples G(z, y). Different sets of these fault images are associated with different fault types, allowing the model to generate a diverse range of synthetic fault samples. This approach addresses the challenge of limited fault data by creating synthetic samples that augment a training dataset used to train a fault classification model to determine a type of bearing fault, potentially improving the performance of subsequent fault classification models.

The image prediction model is trained using training data to generate a specified fault image for a specified fault type from input noise image. The training data includes multiple sets of data. Each set of data includes (a) noise image (e.g., random noise image such as the image represented by Z in FIGS. 3-6, (b) a ground-truth fault image representative of one of the types of a bearing fault (e.g., a 2D image generated from vibration signal data associated with a bearing having a specified fault type), and (c) a bearing fault type associated with the ground-truth fault image. This structured training data allows the image prediction to learn the mapping between random noise inputs and specific fault types. The training process of the image prediction model involves several iterative steps. First, the process involves generating, using a generator of the image prediction model, a predicted fault image based on the noise image and the fault type. That is, the generator of the image prediction model, which is part of the AAC-cGAN architecture, takes the noise image and the fault type as inputs. The generator processes these inputs through its neural network layers to produce a predicted fault image (as discussed in reference to equation (12) above). The process further involves determining, using a discriminator of the image prediction model, whether a difference between the predicted fault image and the ground-truth fault image is less than a specified threshold. Herein, the discriminator of the image prediction model evaluates the authenticity of the predicted fault image. The discriminator considers both the class label y and the presence of added noise. Its output indicates the prediction of how closely the input (e.g., the predicted fault image) resembles a real sample (e.g., ground-truth fault image), as expressed in equation (13) above. The comparison, for determining whether the difference between the predicted fault image and the ground-truth fault image is less than the specified threshold, allows for assessing the quality of the generated images and guiding the training process. Then, the process involves iteratively training the image prediction model until the difference is reduced. That is, the training of the image prediction model continues iteratively until the difference between the predicted fault images and the ground-truth fault images is reduced to an acceptable level. This iterative process involves adjusting the parameters (e.g., weights and biases) of both the generator and the discriminator to improve the quality and authenticity of the generated fault images.

In an embodiment, the training of the image prediction model includes applying spectral normalization to adjust the Lipschitz constant of the discriminator. As discussed, the spectral normalization is a technique used to constrain the Lipschitz constant of neural networks, specifically the discriminator in this case, to enhance training stability. In the context of the AAC-cGAN architecture, the weight matrices W of the discriminator are stabilized by applying spectral normalization, as discussed in reference to equation (14) above. By applying spectral normalization (by using the spectral normalization layer in the discriminator section, as previously discussed), the training process becomes more stable and resistant to issues such as exploding or vanishing gradients. This is particularly important in the context of GANs, where training stability can be a significant challenge. The spectral normalization technique helps to smooth the training process and promotes better convergence of the model. The application of spectral normalization to the discriminator helps in generating high-quality synthetic fault images by ensuring that the discriminator provides reliable feedback to the generator throughout the training process. This, in turn, enables the generator to produce more realistic and diverse fault images, which allows for effective training of the fault prediction model in scenarios with limited or imbalanced fault data.

Additionally, or alternatively, the training of the image prediction model includes an adaptive noise injection mechanism (e.g., as described at least with reference to FIGS. 4-6), which is a key feature of the AAC-cGAN architecture. This process involves several steps to enhance the quality and diversity of generated samples. First, the process involves determining, using a noise generator model, a noise controlling parameter, which is used to control amount of noise added to the noise image. The noise generator model, (e.g., the ANG network), is designed to dynamically generate noise adjustment factors based on the current value of the Generator Loss during training. Specifically, the noise controlling parameter is determined based on the Generator Loss (G_{Loss}) and a threshold value (L_{Th}). As previously detailed in equations (3) to (6), if G_{Loss}≥L_{Th}, the noise controlling parameter α is used to increase the magnitude of adversarial noise (α>1). Conversely, if G_{Loss}≤L_{Th}, the noise controlling parameter β is used to decrease the magnitude of noise (0<β<1) to avoid over-regularization. Next, the process involves modifying the noise image based on the noise controlling parameter to generate noisy image data. This modification process can be represented by the equations previously discussed. Finally, the process involves inputting the noisy image data to the generator to generate the predicted fault image, as previously expressed in equation (12). Such adaptive noise injection process enables the AAC-cGAN to control the magnitude and type of adversarial noise introduced into the generator's input dynamically. This potentially leads to improved quality and diversity of generated bearing fault samples, addressing challenges such as mode collapse and enhancing robustness of the image prediction model against potential adversarial attacks.

In the present embodiments, the noise controlling parameter in the AAC-cGAN architecture includes two distinct parameters. Specifically, the noise controlling parameter includes a first noise controlling parameter and a second noise controlling parameter that is used to add noise to the noise image. Both of these parameters are used to add noise to the noise image, but they serve different purposes and are applied under different conditions. The first noise controlling parameter, previously denoted as α, is used when the Generator Loss (G_{Loss}) is greater than or equal to the threshold value (L_{Th}), as expressed in equation (4). The second noise controlling parameter, previously denoted as β, is used when the G_{Loss} is less than or equal to the L_{Th}, as expressed in equation (6). Herein, the first noise controlling parameter (α) is greater than the second noise controlling parameter (β). Specifically, α is always greater than 1, while β is always between 0 and 1. This relationship ensures that more noise is added when performance of the generator is poor (high loss), and less noise is added when the generator is performing well (low loss). This approach allows for fine-grained control over the noise injection process, enabling the AAC-cGAN to adapt its noise generation strategy based on the current state of performance of the generator. By dynamically adjusting the amount of noise added to the input, the image prediction model can potentially generate more diverse and realistic bearing fault samples, leading to improved fault diagnosis capabilities. In some embodiments, the Generator Loss (G_{Loss}), which is a measure of how well the generator is performing in creating synthetic samples that can fool the discriminator, is extracted each epoch from the training process of the image prediction model.

Further, the process of determining the noise controlling parameter in the AAC-cGAN architecture involves a preliminary training phase for the noise generator model. This phase consists of two main steps. First, the process includes generating a plurality of noise training datasets. Each noise training dataset includes a loss associated with a generator of a second image prediction model and multiple noise controlling parameters generated for the loss. The second image prediction model, as referred herein, is a baseline GAN model used to generate initial training data for the noise generator model. Herein, as previously described, the noise controlling parameters include the first noise controlling parameter that is computed when the loss is greater than a threshold loss, and the second noise controlling parameter that is computed when the loss is lesser than or equal to the threshold loss. Second, the process includes training the noise generator model with the noise training datasets to generate the noise controlling parameter. This training process enables the noise generator model to learn the relationship between the generator loss and the appropriate noise controlling parameters. The noise generator model, implemented as a feed-forward neural network, takes the Generator Loss (G_{Loss}) as input and outputs the noise adjustment factors α and β. The structure of this network, as previously described in equations (7) to (10), includes an input layer, hidden layers, and separate output layers for α and β. By training on these datasets, the noise generator model learns to dynamically generate appropriate noise controlling parameters based on the current generator loss. This adaptive approach allows the AAC-cGAN to fine-tune its noise injection strategy throughout the training process, potentially leading to the generation of more diverse and realistic bearing fault samples. This pre-training of the noise generator model contributes to the overall effectiveness of the adaptive noise injection mechanism in the AAC-cGAN, enhancing its ability to address challenges such as mode collapse and improve the quality of generated samples for bearing fault diagnosis.

Further, in present embodiments, the process of generating the plurality of noise training datasets involves training the second image prediction model to generate a training image that is representative of a given type of fault. Herein, the second image prediction model serves as a baseline for creating the training data for the noise generator model. This training process includes several steps. First, the process includes generating, using the generator of the second image prediction model, the training image based on random image data. This step is similar to the process described earlier for the main AAC-cGAN, where the generator takes random noise as input and produces a synthetic fault image. Next, the process includes determining, using a discriminator of the second image prediction model, whether a difference between the training image and a source image representative of the given type of fault is less than a specified threshold. This step evaluates the quality of the generated training image by comparing it to a real fault image of the same type. The process then involves computing the loss associated with the generator of the second image prediction model. This loss quantifies how well the generator is performing in creating realistic fault images that can fool the discriminator. Following this, the process includes determining the noise controlling parameter based on comparing the loss with the threshold loss. This step applies the same logic as previously described for the main AAC-cGAN, where the noise controlling parameter is set to α (>1) if the loss is above the threshold, and to β (between 0 and 1) if the loss is below or equal to the threshold. Finally, the process includes iteratively training the second image prediction model until the difference is reduced to generate a set of losses and their associated noise parameters as the noise training datasets. In other words, the process involves iteratively training the second image prediction model until the difference between the generated and source images is reduced to an acceptable level. Throughout this iterative process, the process generates a set of losses and their associated noise parameters, which collectively form the noise training datasets. This process allows for the creation of a diverse set of training data for the noise generator model, capturing various scenarios of generator performance and the corresponding appropriate noise parameters. This enables the noise generator model in the main AAC-cGAN to learn to adaptively generate noise controlling parameters based on the current state of the generator, potentially leading to improved quality and diversity of synthetic bearing fault samples.

After the image prediction model (e.g., AAC-cGAN model) is trained, the trained image prediction model is used to generate fault images for various types of bearing faults (e.g., by inputting a random noise image and a fault type to the trained image prediction model). These fault images may then be used as training data to train the fault prediction model (e.g., classification model of FIG. 11) to predict a fault type of the bearing for an input image. That is, following the generation of synthetic fault images, the method 100 involves training the fault prediction model using these fault images as training data. This training process enables the fault prediction model to predict the fault type of a bearing for an input image. In the present implementation, the fault prediction model, by utilizing the synthetic fault images generated by the image prediction model, can learn to recognize a wide variety of fault characteristics, even for fault types that may be underrepresented in the original dataset.

The training process of the fault prediction model includes several key steps. First, the method 100 involves generating a feature vector combination from a first fault image of the fault images, wherein the feature vector combination is a combination of (a) location-agnostic and channel-specific features and (b) location-specific and channel-agnostic features of the first fault image. These features are extracted using a feature extraction model (e.g., the hybrid Involution-Convolution Feature Fusion Network (I-C FFN) described earlier). Such feature vector combinations are generated for all the fault images in the training data and are associated with the corresponding fault types. Accordingly, each fault image the training data may include a feature vector combination and a ground-truth fault type associated with the corresponding fault image. Next, the method 100 involves generating a predicted fault type associated with the first fault image based on the feature vector combination associated with the first fault image. A first loss function associated with the fault prediction model that is indicative of a difference between the predicted fault type and the ground-truth fault type is computed. The training is continued until the first loss function is reduced (e.g., minimized). That is, the training process continues iteratively (e.g., with same training data or different training data), with the model parameters of the fault prediction model being adjusted in every iteration to reduce the first loss function. The training continues until this loss function is reduced to an acceptable level or for a specified number of iterations, indicating that the fault prediction model has learned to accurately classify the fault types based on the input features.

After the training of the fault prediction model is completed, the fault prediction model may be used to predict a fault type for any given input fault image (e.g., by extracting the feature vector combination of the input fault image using the feature extraction model and executing the fault prediction model by inputting the extracted the feature vector combination).

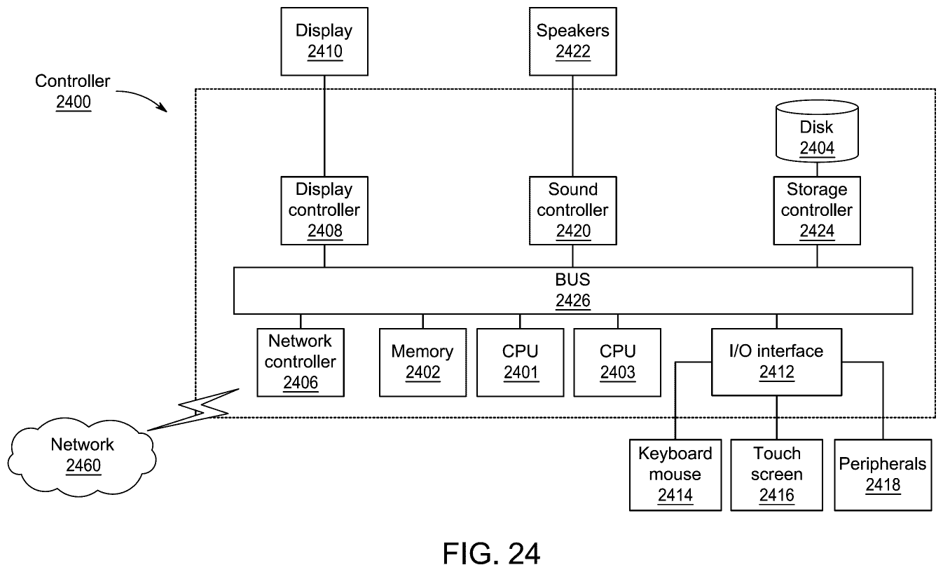

The present disclosure also provides a non-transitory computer-readable storage medium for storing computer-readable instructions. When executed by a computer, these instructions cause the computer to perform a method of training an image prediction model. The details for the said computer have been discussed later in the description in reference to FIGS. 24-27 without any limitations. The purpose of this training is to generate training data for subsequently training a fault prediction model. The fault prediction model is configured to predict a fault type of a bearing based on an image representative of characteristics of the bearing.

The method begins with obtaining multiple sets of data. Each set of data in these multiple sets includes (a) noise image, (b) a ground-truth fault image representative of one of multiple types of a fault of a bearing in a machine, and (c) a fault type associated with the ground-truth fault image. Herein, the noise image serves as the input to the generator. This structured data allows the image prediction model to learn the relationship between random noise inputs, specific fault types, and their corresponding visual representations. Herein, the image prediction model is trained using these sets of data to generate a specified fault image for a specified fault type. This training process of the image prediction model is iterative and includes several steps, as described in the proceeding paragraphs.

First, the method involves generating, using a generator of the image prediction model, a predicted fault image based on the noise image and the fault type. That is, the method uses a generator component of the image prediction model to generate a predicted fault image. This predicted fault image is based on two inputs: the noise image and the fault type. As previously described in the context of the AAC-cGAN architecture, as expressed mathematically in equation (12). Next, the method involves determining, using a discriminator of the image prediction model, whether a difference between the predicted fault image and the ground-truth fault image is less than a specified threshold. That is, the method employs a discriminator component of the image prediction model to evaluate the quality of the generated image. Specifically, the discriminator determines whether the difference between the predicted fault image and the ground-truth fault image is less than a specified threshold. This comparison allows for assessing how well the generator is performing in creating realistic fault images. The method then involves iteratively training the image prediction model until the difference is reduced. In present implementations, the image prediction model is trained until the difference between the predicted and ground-truth images is reduced to an acceptable level. This iterative process involves adjusting the parameters of both the generator and the discriminator to improve the quality and authenticity of the generated fault images.

Throughout this training process, the method may incorporate the adaptive noise injection mechanism and spectral normalization techniques previously described for the AAC-cGAN architecture. These enhancements contribute to the stability of the training process and the quality of the generated images. By storing these instructions on a non-transitory computer-readable storage medium, the method can be readily implemented on various computer systems, allowing for efficient training of image prediction models for bearing fault diagnosis across different hardware configurations. The method of training the image prediction model, as stored on the non-transitory computer-readable storage medium, includes additional techniques to enhance the training process and improve the quality of generated fault images, as discussed in the proceeding paragraphs.

In an embodiment, the method of training the image prediction model includes applying spectral normalization to adjust a Lipschitz constant of the discriminator. As previously described, spectral normalization is used to constrain the Lipschitz constant of the discriminator neural network, enhancing training stability. This process involves normalizing the weight matrices of the discriminator, as expressed in equation (14) above. By applying spectral normalization, the method ensures more stable training and helps prevent issues such as exploding or vanishing gradients.

In another embodiment, the method of training the image prediction model also incorporates an adaptive noise injection mechanism. For this purpose, first, the method includes determining, using a noise generator model, a noise controlling parameter, which is used to control amount of noise added to the noise image. The noise generator model, previously described as the ANG network, dynamically generates noise adjustment factors based on the current state of the training process. After determining the noise controlling parameter, the method includes modifying the noise image based on the noise controlling parameter to generate noisy image data. This modification process follows the previously described equations (3) to (6), and thus not repeated herein for brevity of the present disclosure. The method then includes inputting the noisy image data to the generator to generate the predicted fault image. This generation process follows the previously described equation (12), and thus not repeated herein for brevity of the present disclosure.

In this embodiment, the method of determining the noise controlling parameter includes, first, obtaining a loss associated with the generator during training of the image prediction model. This Generator Loss (G_{Loss}) quantifies how well the generator is performing in creating synthetic samples that can fool the discriminator. Second, the method includes determining, using the noise generator model, the noise controlling parameter based on the loss. This determination is made by comparing the G_{Loss} with a threshold value (L_{Th}), as previously described. This adaptive approach allows the noise generator model to dynamically adjust the level of noise injection based on the current performance of the generator, potentially leading to the generation of more diverse and realistic bearing fault samples.

The method stored on the non-transitory computer-readable storage medium further includes steps for utilizing the trained image prediction model. For this purpose, the method involves during an inference stage, inputting multiple noise images and associated fault types to the image prediction model. Each of these noise images is associated with one of the fault types that the model has been trained to generate. The method then involves executing the image prediction model to generate multiple fault images. These generated fault images include one or more fault images for each of the fault types. This process allows for the creation of a diverse set of synthetic fault images that can be used to augment the training data for the fault prediction model.

Following the generation of these synthetic fault images, the method further includes training a fault prediction model with the fault images as training data to predict a fault type of the bearing for an input image. The training process for the fault prediction model involves several steps. First, the method includes generating a feature vector combination from a first fault image of the fault images. This feature vector combination is created using the previously described hybrid Involution-Convolution Feature Fusion Network (I-C FFN). Herein, the feature vector combination is a combination of (a) location-agnostic and channel-specific features and (b) location-specific and channel-agnostic features of the first fault image. As described, the location-agnostic and channel-specific features are extracted using convolutional operations. These features capture global details and are channel-specific. While the location-specific and channel-agnostic features are extracted using involutional operations. These features are particularly effective at recognizing complex patterns in a channel-agnostic manner, which is beneficial for processing the single-channeled grayscale images of bearing faults. Next, the method includes generating a predicted fault type associated with the first fault image based on the feature vector combination. The fault prediction model processes the combined features to classify the input image into one of several predefined fault categories. Further, the method includes performing the training until a first loss function associated with the fault prediction model is reduced. The first loss function is indicative of a difference between ground-truth fault type associated with the first fault image and the predicted fault type. The training continues, iteratively, until this loss function is reduced to an acceptable level, indicating that the fault prediction model has learned to accurately classify the fault types based on the input features. Thereby, the present method provides an approach to training both the image prediction model and the fault prediction model, enabling effective bearing fault diagnosis even in scenarios with limited or imbalanced fault data.

The present method further comprises steps for applying the trained fault prediction model to actual bearing fault diagnosis. This process begins with obtaining vibration signal data that is representative of characteristics of the bearing. As previously described, the vibration signal data includes a one-dimensional time domain signal, typically acquired using sensors such as accelerometers attached to the housing of the machine containing the bearing. The process then involves converting the vibration signal data to a first image. Herein, the first image is a two-dimensional grayscale image representation of the vibration signal data. This conversion process, as described earlier, includes segmenting the vibration signal data into multiple segments, computing a Gram tensor for each segment, and generating the grayscale image based on the Gram tensor. The tensor values from the Gram tensor are mapped to pixel values of the first image, resulting in a 32×32 grayscale image that visually represents the complex vibrational characteristics of the original signal.

Next, the process includes executing the fault prediction model by inputting the first image to determine a type of fault in the bearing. The execution of the fault prediction model involves two main steps. First, the process involves extracting, using a feature extraction model, multiple feature vectors from the first image that are representative of the characteristics of the bearing. Herein, the feature vectors are extracted using location-agnostic convolution operation and location-specific involution operation. The convolution operation, as described earlier, is performed to obtain a first set of feature vectors that have location-agnostic and channel-specific features of the first image. This operation captures global details and is channel-specific, applying computationally expensive matrix operations with varying weighted kernels for each channel. Simultaneously, the involution operation is performed to obtain a second set of feature vectors that have location-specific and channel-agnostic features of the first image. This operation uses distinct weights for different spatial positions, allowing it to capture spatial dependencies effectively. Finally, the process includes determining, by the fault prediction model, the type of fault in the bearing based on the feature vectors. The fault prediction model, trained on the synthetic fault images generated by the image prediction model, processes these feature vectors to classify the input image into one of several predefined fault categories or as a normal operating condition. This approach, combining advanced signal processing, image conversion, and deep learning techniques, enables the method to provide accurate and reliable fault diagnosis for bearings in industrial machinery, even in scenarios with limited or imbalanced fault data.

The method 100 of determining a type of fault of a bearing in a machine, as per the present disclosure, addresses a crucial need in the field of predictive maintenance. By utilizing the ANG network for class conditional GAN, the method 100 provides an approach for up-sampling bearing failure data. The introduction of adaptive adversarial noise improves the diversity and quality of synthetic data, resulting in more reliable and accurate fault identification. This can significantly reduce unplanned downtime and maintenance costs in industrial settings by providing high-quality up-sampled data that closely resembles real-world bearing failures. The method 100 is particularly resistant to adversarial attacks due to the distinctive ability of the ANG network to generate adaptive noise. This resilience ensures that the fault prediction model trained on this data remains robust and trustworthy even in the face of potential data tampering attempts. This feature enhances the reliability and security of predictive maintenance systems. Additionally, the method 100 incorporates a computationally efficient feature extraction and classification network based on the combination of convolution and involution operations. This feature extraction approach maintains computational economy while achieving excellent fault detection accuracy, making the method 100 suitable for implementation in settings with limited resources, such as real-time monitoring systems or edge devices.

The method 100 leverages the phenomenon of stochastic resonance by introducing adaptive noise in the training of the generator, which amplifies weak signal characteristics. This approach allows the generator to more accurately capture and reflect the underlying properties of the input data, especially in situations with low signal-to-noise ratios. By dynamically modifying noise settings based on the generator loss, the method 100 enhances the training process, resulting in more realistic and accurate synthetic data production. This improvement in data quality also contributes to ability of the method 100 to resist adversarial attacks, further strengthening the robustness and reliability of the fault prediction model for real-world applications in bearing fault diagnosis.

### EXAMPLES

The experimental analysis was conducted using CWRU (Case-Western-Reserve University) rolling bearing dataset, a widely recognized and open-source benchmark dataset for bearing fault diagnosis. This dataset was developed by the Center-For-Intelligent Maintenance Systems (IMS) at Case Western Reserve University to provide a standardized dataset for evaluating and comparing different fault diagnosis methods and algorithms. The CWRU dataset was designed to simulate real-world conditions of various bearing faults, incorporating signals associated with different fault types. It comprised vibration signals recorded using an accelerometer from four sets of rolling element bearings operating under diverse conditions, including normal and faulty scenarios. The bearings used were deep groove type, specifically 6205/2RS JEM SKF and 6203-2RS JEM SKF.

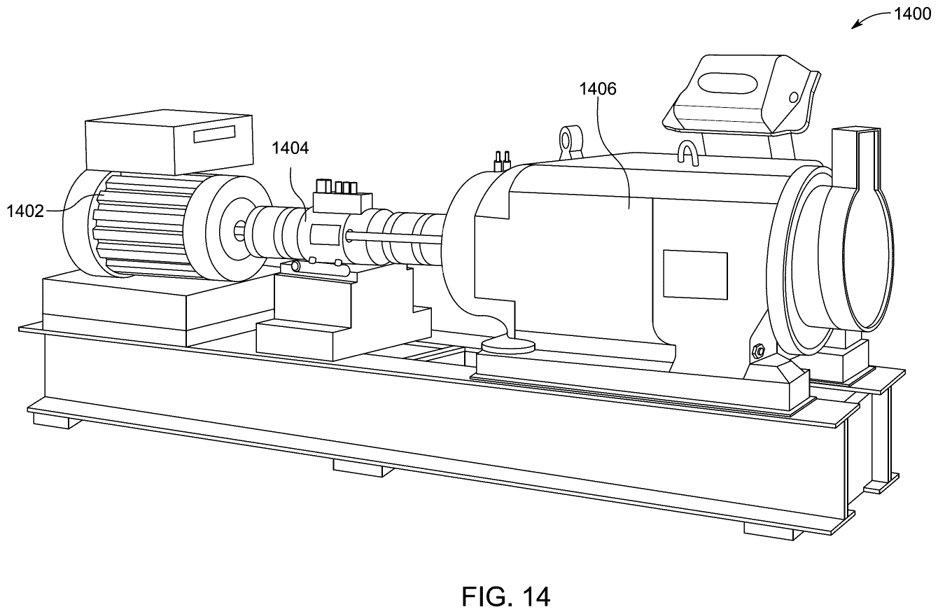

The data extraction procedure involved a bearing fault acquisition setup 1400 with a set of equipment, including a motor 1402 of about 2-horsepower, a transducer 1404, and a dynamometer 1406, as illustrated in FIG. 14 of the present disclosure. Different fault conditions were intentionally introduced to individual bearings, encompassing inner-race, outer-race, and ball-faults, as well as combinations thereof. To ensure realism and consistency, fault sizes were precisely controlled. The faults were integrated at specific points to create fault sizes on bearing races and balls. The respective faults were introduced in the test bearings supporting the motor shaft using electro-discharge machining, with fault diameters ranging from 7 mils to 40 mils, where 1 inch equaled 1000 mils. NTN and SKF bearings (as known and widely used) were employed for different fault diameters, with 28 and 40 mils for NTN bearings and 7, 14, and 21 mils for SKF bearings. Accelerometers (not shown) were affixed to the housing with magnetic bases to extract vibrational data.

The data acquisition process involved rotating the bearings at distinct speeds and conditions to capture signal details under varying operating conditions. Acceleration data was collected from sensors placed at different locations, including perpendicular to fan and drive ends of housing of the motor 1402. The acquisition sampling rates were 12,000 samples per second and 48,000 samples per second for drive end bearing faults. Additionally, the transducer 1404, which may be the torque transducer, was used to extract speed and horsepower data. For comprehensive analysis, the response to outer raceway faults was studied by strategically positioning faults relative to the load zones. For both the fan and drive-end bearings, impact quantification was conducted via a series of experiments involving the placement of outer raceway faults at different orientations.

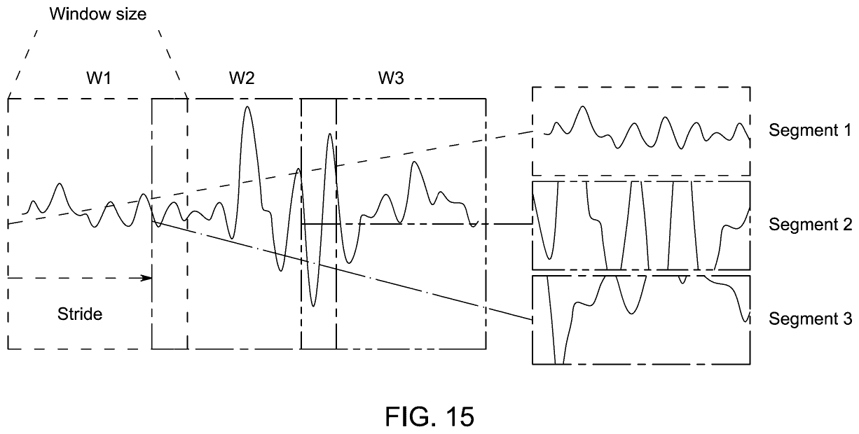

The experimental evaluation of the method 100 was conducted using a fault dataset with 48K samples. Fault diameters of 0.007, 0.014, and 0.021 inches were considered at zero and one horsepower (0 HP, 1 HP) conditions for classification. Normal baseline data was also merged with the fault data for comprehensive classification. The raw signals were segmented using a window size of 1024 with a stride size of 500, as illustrated in FIG. 15. This stride size ensured that correlations and patterns between successive segments were captured.

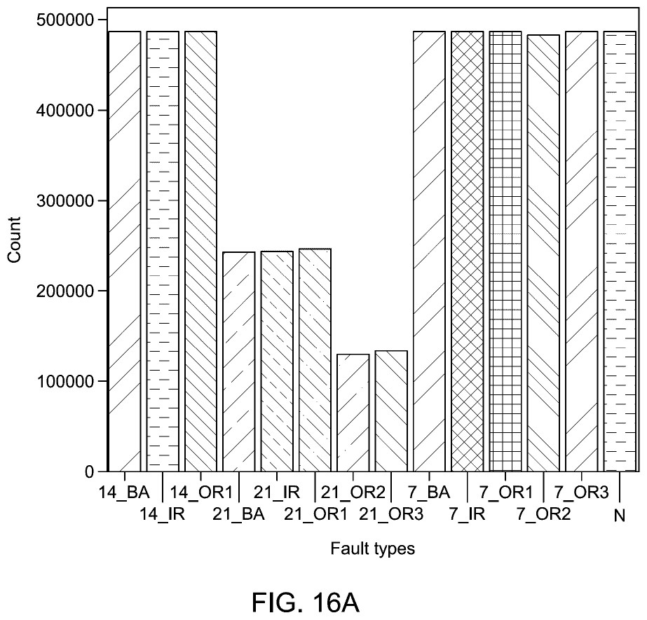

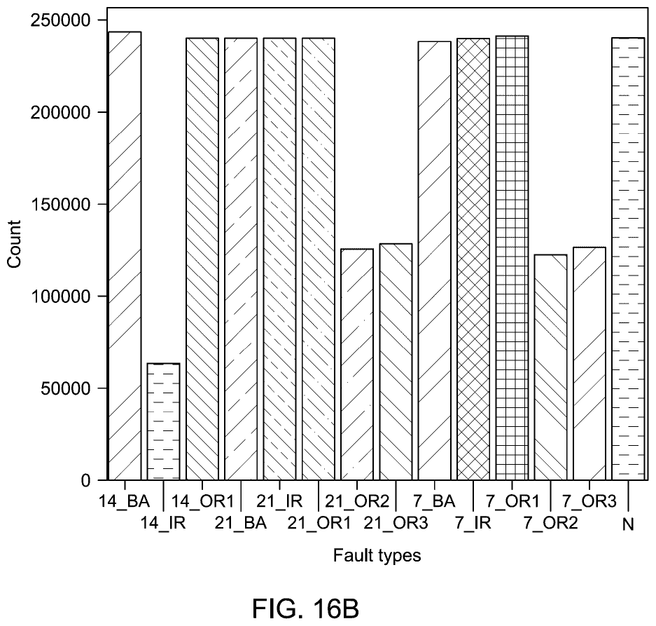

FIG. 16A and FIG. 16B show the class distribution of imbalanced fault data for No-Load (N-L) and Single-Load (S-L) conditions, respectively. Each condition contained 13 fault classes and a healthy class. The numbers before the underscore represent fault diameters in inches, while OR, IR, and BA represent Outer Race, Inner Race, and Ball Faults. The number with the OR class indicates the orientation at which faults were induced.

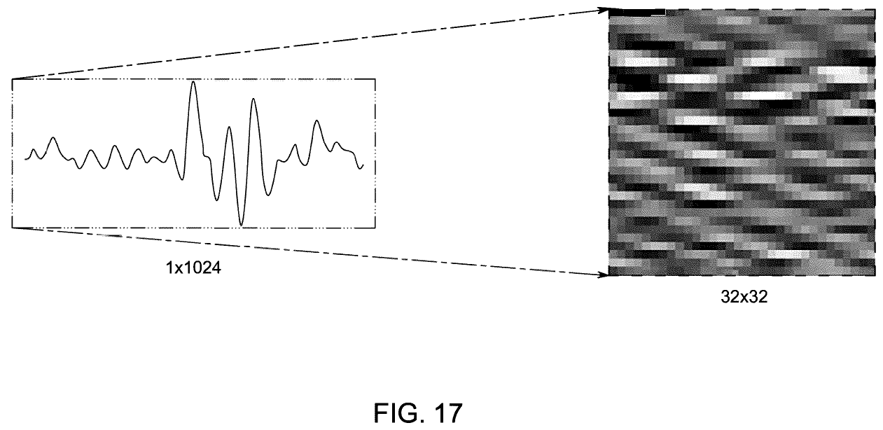

As depicted in FIG. 17, the segmented signals were reshaped into 2-dimensional grayscale image representations of size 32×32. This conversion allowed for harnessing the spatial feature extraction capabilities of convolutional and attention-based feature extraction methods without explicit noise reduction or preprocessing.

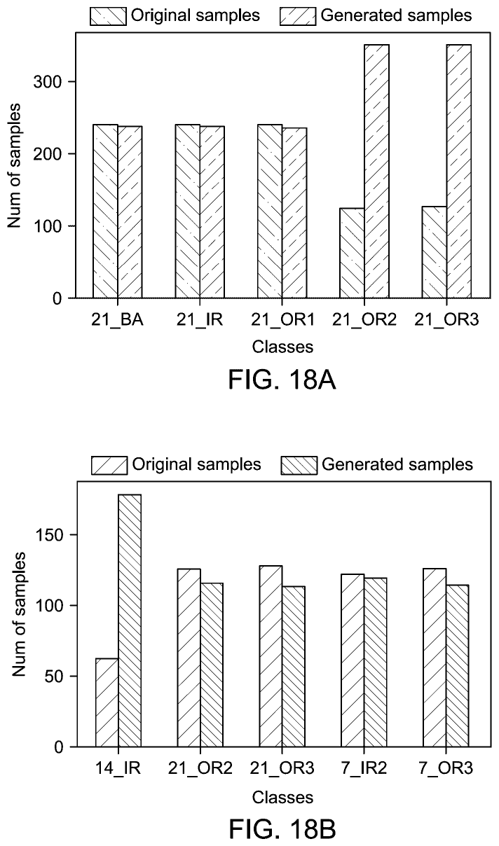

The AAC-cGAN was implemented on the imbalanced dataset for effective oversampling. FIG. 18A and FIG. 18B illustrate the upsampling ratio of imbalanced classes for N-L and S-L conditions, respectively. The grayscale image dataset was first subjected to a baseline GAN model for generative loss extraction, training for 300 epochs. Subsequently, a secondary ANG model was trained on the acquired generative loss, taking generative loss as input and outputting adjustment parameters a and J.

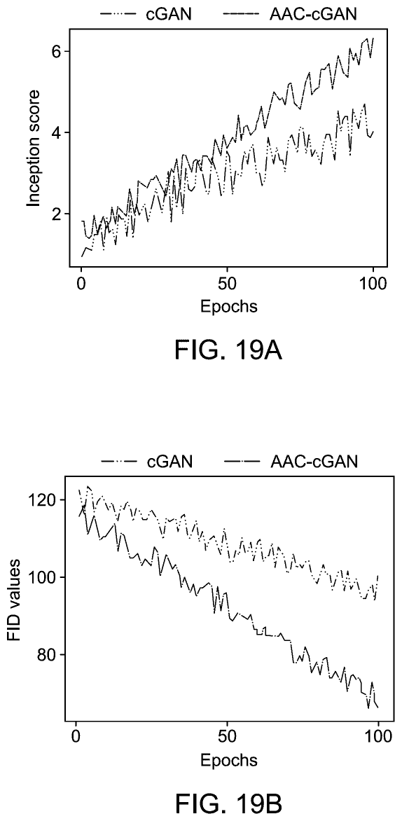

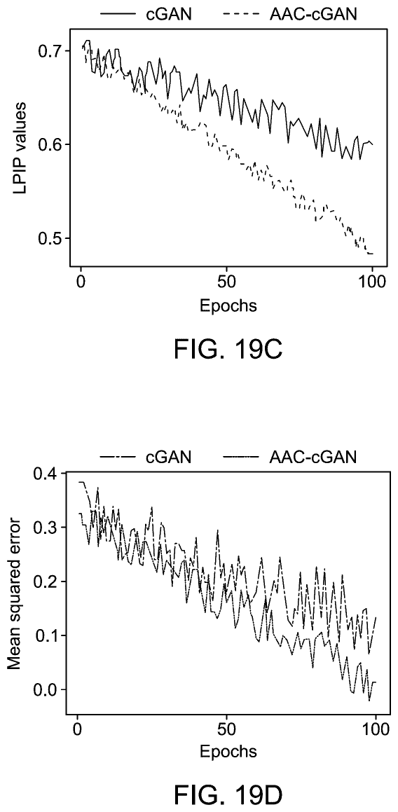

The AAC-cGAN model was trained for 100 epochs and evaluated using multiple metrics. FIGS. 19A-D provide epoch-wise assessments of inception score, Frechet inception distance, learned perceptual image patch similarity, and mean squared error for both cGAN and AAC-cGAN models. The inception score for the baseline cGAN reached 3.8, while the AAC-cGAN achieved 6.1. The Frechet Inception Distance (FID) for cGAN was 103, while the AAC-cGAN achieved 67.5. Similarly, another metric Learned Perceptual Similarity Patch (LPIP) metric is employed to evaluate the perceptual similarity levels. This metric holds great significance as it quantifies the similarity levels similar to human vision. The curve in the figure shows a stable fall towards an improved LPIP score for both the cGAN and AAC-cGAN. The last metric is the MSE which although is not a direct evaluation of the generative models, but provides an insight into the fidelity of the model. Being a full reference metric, the lower values are considered better. Hence the above metrics allude to a quantitative estimation of improved image generation by the proposed model. It can be seen that the proposed technique clearly outpaces the baseline cGAN network in all quality metrics.

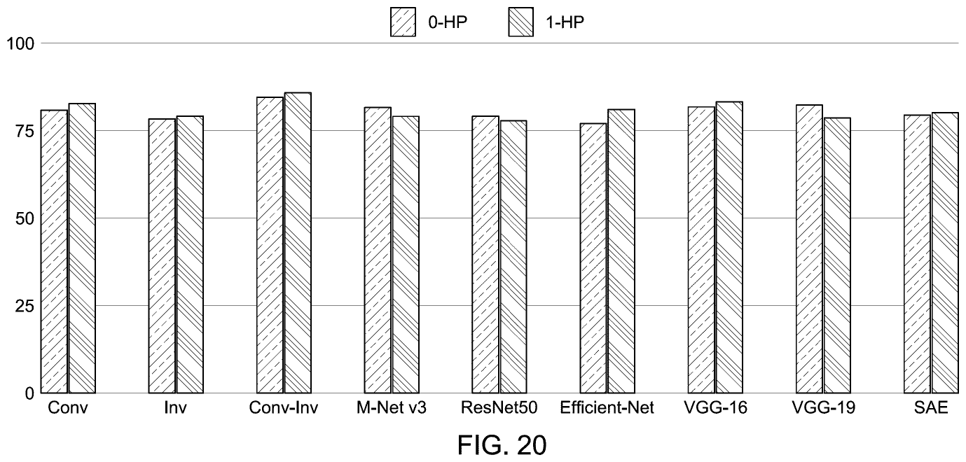

In order to get a more comprehensive evaluation of the proposed scheme, the experimental procedures were conducted on different combinations. Initial experiments were performed on the dataset with no-load (N-L) and single load (S-L) conditions (0-HP and 1-HP) without any oversampling. Multiple pre-trained and custom networks were used for this purpose. FIG. 20 illustrates the accuracy assessment for imbalanced datasets on custom and pre-trained networks. The highest accuracy achieved was 85.94% and 83.46% by the proposed I-C FFN network for the 0 HP and 1 HP load conditions, respectively. Among pre-trained networks, VGG-19 reached the highest accuracy of 82.33% for N-L condition, while VGG-16 achieved 81.75% for S-L condition. The acquired accuracy values for under-sampled experimentations are given in Table 2 below. These results indicated significant room for improvement on the baseline results. The lower accuracy was attributed to the pre-trained networks not being acclimatized to the specific domain, resulting in mediocre performance. Additionally, under-sampled representations made some classes difficult to classify due to sample scarcity.

TABLE 2
Evaluation of models without oversampling.

| | | | | F1- | K. | Matt. |
|---|---|---|---|---|---|---|
| Models | Accuracy | Recall | Precision | Score | Stats | Corr. |
| Conv | 79.56 | 79.28 | 79.84 | 79.56 | 80.24 | 80.24 |
| | 80.24 | 80.04 | 80.44 | 80.24 | 80.64 | 80.64 |
| Inv | 77.26 | 77.04 | 77.48 | 77.26 | 78.84 | 78.84 |
| | 78.84 | 78.64 | 79.04 | 78.84 | 79.44 | 79.44 |
| I-C FFN | 83.46 | 83.22 | 83.69 | 83.46 | 85.94 | 85.94 |
| | 85.94 | 85.74 | 86.14 | 85.94 | 87.34 | 87.34 |
| M-Net | 80.97 | 80.77 | 81.17 | 80.97 | 78.99 | 78.99 |
| | 78.99 | 78.79 | 79.19 | 78.99 | 79.79 | 79.79 |
| ResNet | 79.56 | 79.34 | 79.78 | 79.56 | 77.94 | 77.94 |
| | 77.94 | 77.74 | 78.14 | 77.94 | 79.14 | 79.14 |
| Eff.Net | 76.24 | 76.04 | 76.44 | 76.24 | 79.87 | 79.87 |
| | 79.87 | 79.67 | 80.07 | 79.87 | 81.27 | 81.27 |
| VGG-16 | 80.94 | 80.75 | 81.13 | 80.94 | 81.75 | 81.75 |
| | 81.75 | 81.55 | 81.95 | 81.75 | 82.55 | 82.55 |
| VGG-19 | 82.33 | 82.11 | 82.55 | 82.33 | 80.06 | 80.06 |
| | 80.06 | 79.86 | 80.26 | 80.06 | 80.86 | 80.86 |
| SAE | 80.13 | 79.94 | 80.32 | 80.13 | 80.95 | 80.95 |
| | 80.95 | 80.75 | 81.15 | 80.95 | 81.75 | 81.75 |

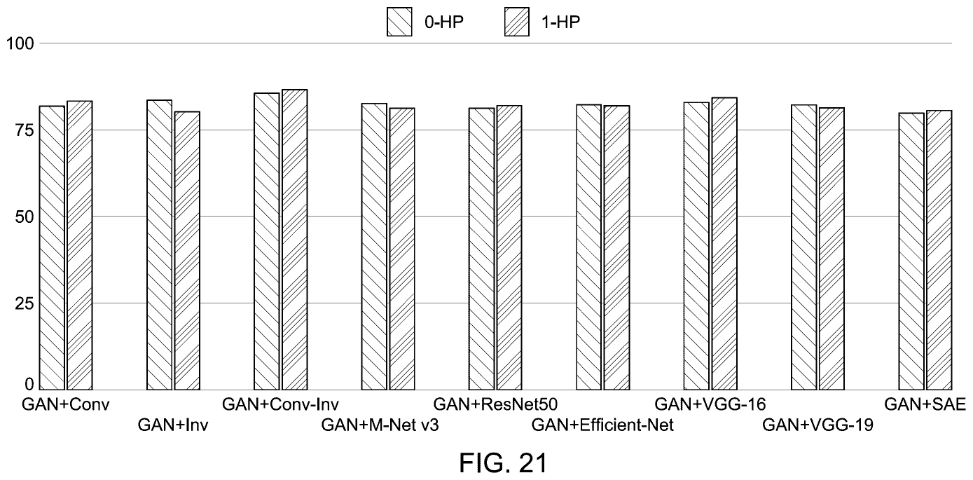

Following these initial tests, multiple experiments were performed with the oversampled dataset using the proposed and established techniques. FIG. 21 shows the accuracy assessment for cGAN-based upsampling on custom and pre-trained networks. The results after oversampling using baseline GAN provided some improvements, though not significantly. The highest accuracy attained was 86.09% on S-L and 85.13% on N-L condition by the proposed classification model, representing an increase of approximately 1.5% for N-L and 1% for S-L compared to the non-oversampled results (as shown in the Table 3 below). The success of the proposed model in both evaluations was attributed to its global and local feature extraction capability, making it adept at tasks involving both channel-agnostic and channel-specific data.

TABLE 3
Evaluation of models with cGAN based over-sampling

| | | | | F1- | K. | Matt. |
|---|---|---|---|---|---|---|
| Models | Accuracy | Recall | Precision | Score | Stats | Corr. |
| Conv. | 81.04 | 80.83 | 81.25 | 81.04 | 82.76 | 82.76 |
| | 82.76 | 82.56 | 83.06 | 82.76 | 83.56 | 83.56 |
| Inv. | 82.47 | 82.25 | 82.69 | 82.47 | 79.84 | 79.84 |
| | 79.84 | 79.64 | 80.04 | 79.84 | 80.44 | 80.44 |
| I-C FFN | 85.13 | 84.95 | 85.31 | 85.13 | 86.09 | 86.09 |
| | 86.09 | 85.90 | 86.28 | 86.09 | 87.18 | 87.18 |
| M-Net | 81.07 | 80.91 | 81.23 | 81.07 | 80.21 | 80.21 |
| | 80.21 | 80.01 | 80.41 | 80.21 | 80.81 | 80.81 |
| ResNet | 80.44 | 80.28 | 80.60 | 80.44 | 80.97 | 80.97 |
| | 80.97 | 80.77 | 81.17 | 80.97 | 81.77 | 81.77 |
| Eff.Net | 81.36 | 81.20 | 81.52 | 81.36 | 81.18 | 81.18 |
| | 81.18 | 81.00 | 81.38 | 81.18 | 81.78 | 81.78 |
| VGG-16 | 83.92 | 83.75 | 84.09 | 83.92 | 84.77 | 84.77 |
| | 84.77 | 84.57 | 85.07 | 84.77 | 85.57 | 85.57 |
| VGG-19 | 83.97 | 83.79 | 84.15 | 83.97 | 82.91 | 82.91 |
| | 82.91 | 82.71 | 83.11 | 82.91 | 83.71 | 83.71 |
| SAE | 81.87 | 81.71 | 82.03 | 81.87 | 82.09 | 82.09 |
| | 82.09 | 81.91 | 82.29 | 82.09 | 82.89 | 82.89 |

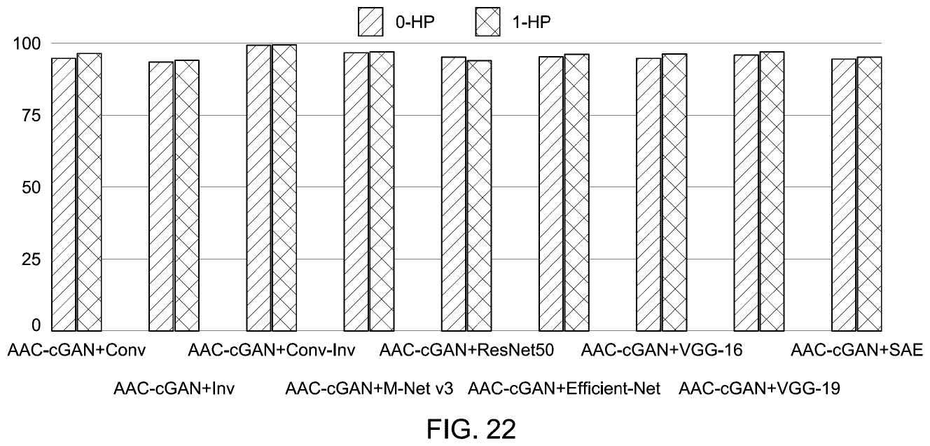

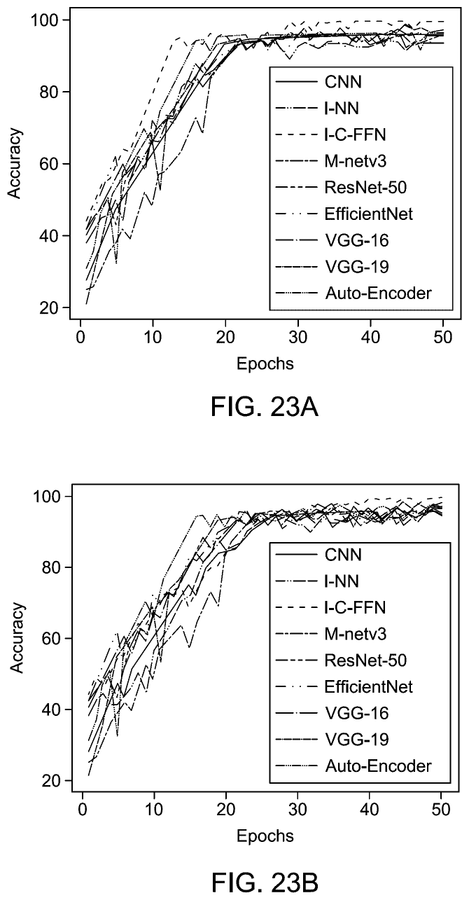

FIG. 22 provides the accuracy assessment for AAC-cGAN based upsampling on custom and pre-trained networks. After implementing AAC-cGAN based oversampling, the training curves were more stable and the quantitative assessments provided a more comprehensive overview. The highest accuracy values achieved after applying AAC-cGAN on the synthetically oversampled dataset were 99.40% and 99.61% (as shown in the Table 4 below) for the proposed I-C FFN method, followed closely by VGG-19 with accuracy values of 97.72% and 98.26% for N-L and S-L conditions, respectively. FIG. 23A and FIG. 23B provide the accuracy curves of the proposed and pre-trained models for accuracy values in N-L and S-L conditions, respectively. These charts demonstrate the superior performance of the proposed method compared to pre-trained models across different load conditions. The experimental results highlighted the effectiveness of the AAC-cGAN based oversampling in improving classification accuracy for bearing fault diagnosis, particularly in scenarios with imbalanced datasets.

TABLE 4
Evaluation of models with AAC-cGAN for N-L and S-L

| | | | | F1- | K. | Matt. |
|---|---|---|---|---|---|---|
| Models | Accuracy | Recall | Precision | Score | Stats | Corr. |
| Conv. | 95.51 | 94.27 | 94.26 | 95.11 | 95.45 | 95.44 |
| | 96.55 | 95.12 | 95.33 | 96.15 | 96.21 | 96.33 |
| Inv. | 93.53 | 93.45 | 92.29 | 93.12 | 93.56 | 93.54 |
| | 94.57 | 94.25 | 94.29 | 94.24 | 94.17 | 94.17 |
| I-C FFN | 99.40 | 99.34 | 99.41 | 99.37 | 99.35 | 99.37 |
| | 99.61 | 99.63 | 99.59 | 99.61 | 99.62 | 99.62 |
| M-Net | 96.21 | 96.11 | 96.39 | 96.25 | 96.28 | 96.27 |
| | 97.13 | 97.34 | 97.08 | 97.16 | 97.19 | 97.18 |
| ResNet | 95.63 | 95.02 | 95.93 | 95.72 | 95.75 | 95.74 |
| | 95.61 | 95.17 | 95.67 | 95.49 | 95.52 | 95.51 |
| Eff.Net | 96.13 | 96.01 | 96.37 | 96.21 | 96.23 | 96.22 |
| | 96.55 | 96.73 | 96.41 | 96.52 | 96.55 | 96.54 |
| VGG-16 | 96.02 | 97.08 | 96.37 | 96.67 | 96.71 | 96.69 |
| | 96.99 | 97.13 | 96.69 | 96.71 | 95.94 | 95.97 |
| VGG-19 | 97.72 | 97.59 | 97.47 | 97.35 | 97.37 | 97.34 |
| | 98.26 | 97.93 | 98.14 | 98.16 | 98.28 | 98.19 |
| SAE | 96.23 | 96.02 | 96.05 | 96.13 | 96.27 | 96.27 |
| | 96.78 | 96.55 | 96.32 | 96.21 | 96.15 | 96.16 |

The proposed method was compared with existing works (see Table 5 below), including Signals To Spectrograms [See: Y Yoo, H. Jo, and S.-W Ban, “Lite and efficient deep learning model for bearing fault diagnosis using the CWRU dataset,” Sensors, vol. 23, no. 6, p. 3157, March 2023, incorporated herein by reference in its entirety]; Signal to Wavelet [See: M Kahr; G. Kovács, M. Loinig, and H. Brückl, “Condition monitoring of ball bearings based on machine learning with synthetically generated data,” Sensors, vol. 22, no. 7, p. 2490, March 2022, incorporated herein by reference in its entirety]; Signal to Wavelet [See: H. N. Monday, J. Li, G. U. Nneji, S. Nahar, M. A. Hossin, J Jackson, and A. Oluwasanmi, “A wavelet convolutional capsule network with modified super resolution generative adversarial network for fault diagnosis and classification,” Complex Intell. Syst., vol. 8, no. 6, pp. 4831-4847, December 2022, incorporated herein by reference in its entirety]; Signal To Gray Scale Images [See: S. Ayas and M. S. Ayas, “A novel bearing fault diagnosis method using deep residual learning network,” Multimedia Tools Appl., vol. 81, no. 16, pp. 22407-22423, July 2022, incorporated herein by reference in its entirety]; and Signal To Scattergram [See: B. U. Deveci, M. Celtikoglu, O. Albayrak, P. Unal, and P. Kirci, “Transfer learning enabled bearing fault detection methods based on image representations of single-dimensional signals,” Inf Syst. Frontiers, February 2023, incorporated herein by reference in its entirety], revealing several advantages. The combination of conditional Generative Adversarial Network (cGAN) and adaptive adversarial noise not only increased the quantity of training data but also enhanced the model's resilience against noisy data and potential adversarial attacks. This aspect was often overlooked in other studies where authors used normalization-based imbalance handling, traditional generative techniques, or non-adaptive noise injection approaches. Some studies did not consider both stability and adversarial robustness, while those that integrated noise injection did not emphasize the adaptive nature of injection which could control the extent of injected noise and maintain overall stability.

TABLE 5
Comparison of proposed model with existing works

| Method | Description | Dataset | Accuracy | Drawbacks |
|---|---|---|---|---|
| Signals To | Lite Convolutional Neural Network | CWRU | 99.65% | Limited to spectral |
| Spectrograms | | | | features |
| Signal to | Vibration data with Noise super- | CWRU | 92.5% | Requires complex |
| Wavelet | imposition for classification | | | simulations |
| Signal To | SuperResolution GAN and Wavelet | CWRU | 99.92% | Sensitive to noisy |
| Wavelet | Convolutional Capsule Network | | | data |
| Signal To Gray | Novel Deep Residual Network | CWRU | 99.98% | Limited to grayscale |
| Scale Images | | | | information |
| Signal To | Ensemble Of Multiple Imaging | CWRU | 99.89% | Requires integration |
| Scattergram | Methods and Res-Net50 | | | of various methods |
| Signal to Gray | Novel AAC-cGAN for oversampling, | CWRU | 99.61% (1-HP) | Computational resource |
| Scale Images | Involution-Convolution Hybrid | | 99.40% (0-HP) | requirements |
| | feature extraction | | | |

The proposed involution and convolution-based feature extraction scheme in the method 100 was the first of its kind within the domain of bearing fault classification. This technique was chosen as a feature extractor for its significant advantage in effectively capturing spatial dependencies in a channel-agnostic manner, enabling it to recognize intricate patterns. Meanwhile, the complementary convolution operation was adept at detecting fundamental features and structures globally. The combination of these two approaches achieved a more comprehensive understanding of the data and patterns compared to studies relying solely on convolutions or tedious hand-crafted features.

In conclusion, the method 100 introduced a novel approach towards addressing the critical issue of bearing fault detection. The method 100 combined Conditional Generative Adversarial Networks (CGANs) with spectral normalization and adaptive adversarial noise injection, demonstrating remarkable effectiveness in generating high-quality bearing fault samples. By reducing the risk of mode collapse and vanishing gradients, the method 100 enhanced the generalization and robustness of CGAN training, leading to more stable and reliable results. The introduction of the I-C FFN feature extraction method, combining involution and convolution techniques for bearing fault classification, further enriched the diagnostic capabilities of the method 100 by capturing both local and global information. This proved versatile in handling various feature types, including channel-agnostic, spatial-specific, spatial-agnostic, and channel-specific characteristics. The gray-scaled converted bearing fault samples served as an ideal utility for the channel-agnostic and channel-specific capabilities of the proposed involution-convolution synergy, yielding significant improvement in classification. The oversampling methodology of the method 100 not only boosted the performance of the classification scheme but also outperformed state-of-the-art transfer learning models, achieving impressive accuracy for both balanced and imbalanced schemes. The inclusion of the AAC-cGAN significantly improved sample quality and robustness to noise, as demonstrated by various evaluation metrics employed in the study.

Next, further details of the hardware description of a computing environment according to exemplary embodiments is described with reference to FIG. 24. In FIG. 24, a controller 2400 is described is representative of the computer, in which the controller 2400 is a computing device which includes a CPU 2401 which performs the processes described above/below. The process data and instructions may be stored in memory 2402. These processes and instructions may also be stored on a storage medium disk 2404 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 2401, 2403 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 2401 or CPU 2403 may be a Xenon or Core processor from Intel of America or an Opteron processor from AMD of America, or may be other processor types that would be recognized by one of ordinary skill in the art. Alternatively, the CPU 2401, 2403 may be implemented on an FPGA, ASIC, PLD or using discrete logic circuits, as one of ordinary skill in the art would recognize. Further, CPU 2401, 2403 may be implemented as multiple processors cooperatively working in parallel to perform the instructions of the inventive processes described above.

The computing device in FIG. 24 also includes a network controller 2406, such as an Intel Ethernet PRO network interface card from Intel Corporation of America, for interfacing with network 2460. As can be appreciated, the network 2460 can be a public network, such as the Internet, or a private network such as an LAN or WAN network, or any combination thereof and can also include PSTN or ISDN sub-networks. The network 2460 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 2408, such as a NVIDIA GeForce GTX or Quadro graphics adaptor from NVIDIA Corporation of America for interfacing with display 2410, such as a Hewlett Packard HPL2445w LCD monitor. A general purpose I/O interface 2412 interfaces with a keyboard and/or mouse 2414 as well as a touch screen panel 2416 on or separate from display 2410. General purpose I/O interface also connects to a variety of peripherals 2418 including printers and scanners, such as an OfficeJet or DeskJet from Hewlett Packard.

A sound controller 2420 is also provided in the computing device such as Sound Blaster X-Fi Titanium from Creative, to interface with speakers/microphone 2422 thereby providing sounds and/or music.

The general purpose storage controller 2424 connects the storage medium disk 2404 with communication bus 2426, which may be an ISA, EISA, VESA, PCI, or similar, for interconnecting all of the components of the computing device. A description of the general features and functionality of the display 2410, keyboard and/or mouse 2414, as well as the display controller 2408, storage controller 2424, network controller 2406, sound controller 2420, and general purpose I/O interface 2412 is omitted herein for brevity as these features are known.

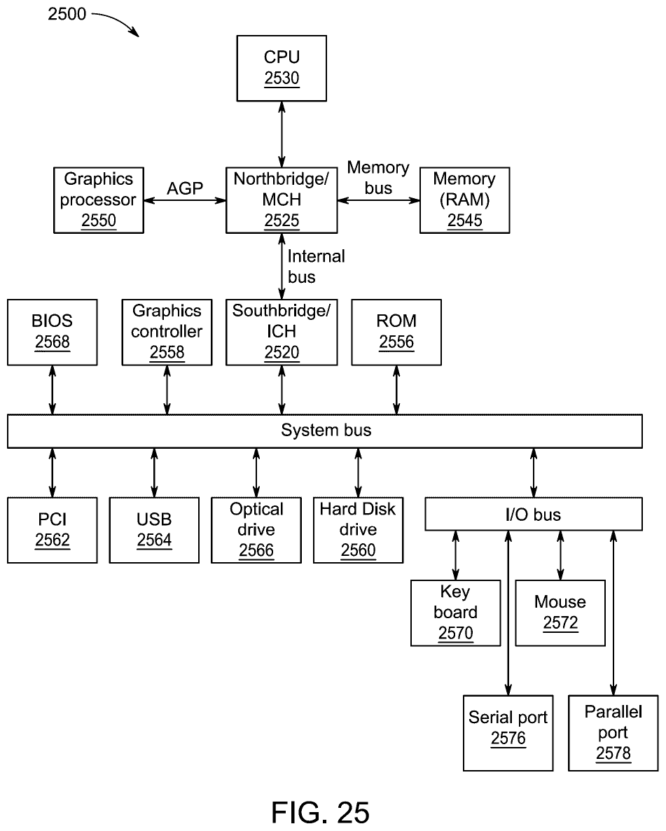

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 25.

FIG. 25 shows a schematic diagram of a data processing system, according to certain embodiments, for performing the functions of the exemplary embodiments. The data processing system is an example of a computer in which code or instructions implementing the processes of the illustrative embodiments may be located.

In FIG. 25, data processing system 2500 employs a hub architecture including a north bridge and memory controller hub (NB/MCH) 2525 and a south bridge and input/output (I/O) controller hub (SB/ICH) 2520. The central processing unit (CPU) 2530 is connected to NB/MCH 2525. The NB/MCH 2525 also connects to the memory 2545 via a memory bus, and connects to the graphics processor 2550 via an accelerated graphics port (AGP). The NB/MCH 2525 also connects to the SB/ICH 2520 via an internal bus (e.g., a unified media interface or a direct media interface). The CPU Processing unit 2530 may contain one or more processors and even may be implemented using one or more heterogeneous processor systems.

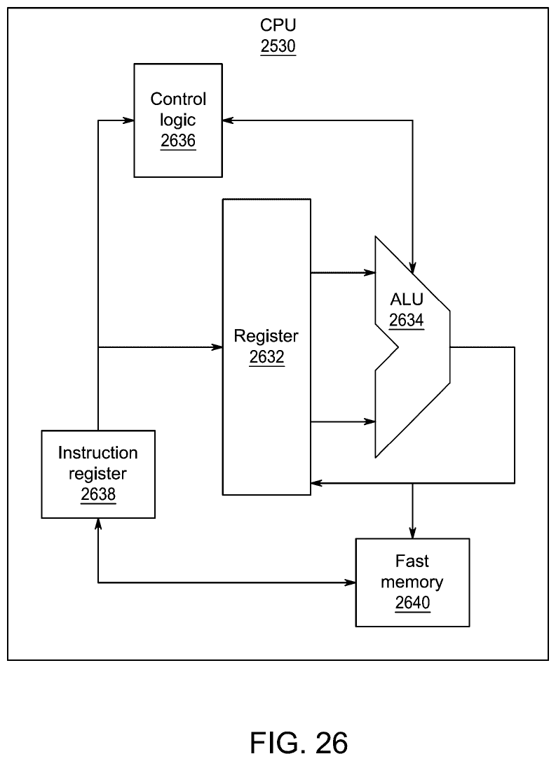

For example, FIG. 26 shows one implementation of CPU 2530. In one implementation, the instruction register 2638 retrieves instructions from the fast memory 2640. At least part of these instructions are fetched from the instruction register 2638 by the control logic 2636 and interpreted according to the instruction set architecture of the CPU 2530. Part of the instructions can also be directed to the register 2632. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 2634 that loads values from the register 2632 and performs logical and mathematical operations on the loaded values according to the instructions. The results from these operations can be feedback into the register and/or stored in the fast memory 2640. According to certain implementations, the instruction set architecture of the CPU 2530 can use a reduced instruction set architecture, a complex instruction set architecture, a vector processor architecture, a very large instruction word architecture. Furthermore, the CPU 2530 can be based on the Von Neuman model or the Harvard model. The CPU 2530 can be a digital signal processor, an FPGA, an ASIC, a PLA, a PLD, or a CPLD. Further, the CPU 2530 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 25, the data processing system 2500 can include that the SB/ICH 2520 is coupled through a system bus to an I/O Bus, a read only memory (ROM) 2556, universal serial bus (USB) port 2564, a flash binary input/output system (BIOS) 2568, and a graphics controller 2558. PCI/PCIe devices can also be coupled to SB/ICH 2588 through a PCI bus 2562.

The PCI devices may include, for example, Ethernet adapters, add-in cards, and PC cards for notebook computers. The Hard disk drive 2560 and CD-ROM 2566 can use, for example, an integrated drive electronics (IDE) or serial advanced technology attachment (SATA) interface. In one implementation the I/O bus can include a super I/O (SIO) device.

Further, the hard disk drive (HDD) 2560 and optical drive 2566 can also be coupled to the SB/ICH 2520 through a system bus. In one implementation, a keyboard 2570, a mouse 2572, a parallel port 2578, and a serial port 2576 can be connected to the system bus through the I/O bus. Other peripherals and devices that can be connected to the SB/ICH 2520 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

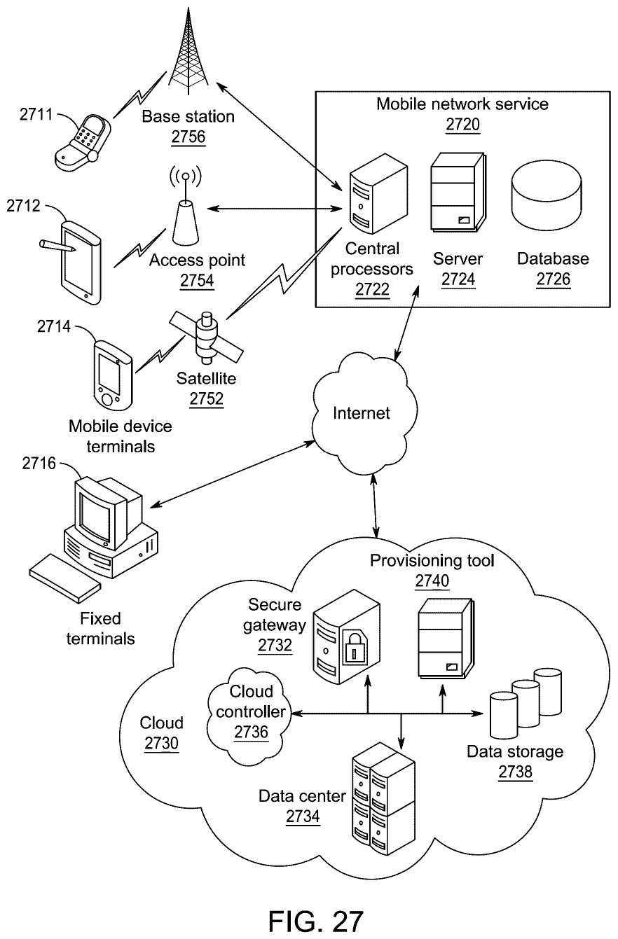

The functions and features described herein may also be executed by various distributed components of a system. For example, one or more processors may execute these system functions, wherein the processors are distributed across multiple components communicating in a network. The distributed components may include one or more client and server machines, such as cloud 2730 including a cloud controller 2736, a secure gateway 2732, a data center 2734, data storage 2738 and a provisioning tool 2740, and mobile network services 2720 including central processors 2722, a server 2724 and a database 2726, which may share processing, as shown by FIG. 27, in addition to various human interface and communication devices (e.g., display monitors 2716, smart phones 2710, tablets 2712, personal digital assistants (PDAs) 2714). The network may be a private network, such as a LAN, satellite 2752 or WAN 2754, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method of determining a type of fault of a bearing in a machine, the method comprising:
obtaining vibration signal data that is representative of characteristics of a bearing in a machine, wherein the vibration signal data includes a one-dimensional time domain signal;
converting the vibration signal data to a first image, wherein the first image is a two-dimensional grayscale image representation of the vibration signal data; and
executing a fault prediction model by inputting the first image to determine a type of fault in the bearing, wherein the executing includes:
extracting, using a feature extraction model, multiple feature vectors from the first image that are representative of the characteristics of the bearing, wherein the feature vectors are extracted using location-agnostic convolution operation and location-specific involution operation, and
determining, by the fault prediction model, the type of fault in the bearing based on the feature vectors.

2. The method of claim 1, wherein extracting the feature vectors includes:
performing a convolution operation on the first image to obtain a first set of feature vectors that have location-agnostic and channel-specific features of the first image,
performing an involution operation on the first image to obtain a second set of feature vectors that have location-specific and channel-agnostic features of the first image, and
concatenating the first set of feature vectors and the second set of feature vectors to generate a concatenated set of feature vectors, which is used as an input to the fault prediction model to determine the type of fault.

3. The method of claim 1 further comprising:
obtaining, using an image prediction model, multiple fault images from noise data, wherein different sets of the fault images are associated with different fault types, wherein the image prediction model is trained to generate a specified fault image for a specified fault type from input noise image.

4. The method of claim 3 further comprising:
training the fault prediction model with the fault images as training data to predict a fault type of the bearing for an input image.

5. The method of claim 4, wherein the training includes:
generating a feature vector combination from a first fault image of the fault images, wherein the feature vector combination is a combination of (a) location-agnostic and channel-specific features and (b) location-specific and channel-agnostic features of the first fault image,
generating a predicted fault type associated with the first fault image based on the feature vector combination, and
performing the training until a first loss function associated with the fault prediction model is reduced, wherein the first loss function is indicative of a difference between ground-truth fault type associated with the first fault image and the predicted fault type.

6. The method of claim 3 further comprising:
training the image prediction model using training data to generate the specified fault image for the specified fault type, the training data including multiple sets of data, wherein each set of data includes (a) noise image, (b) a ground-truth fault image representative of one of the types of a fault, and (c) a fault type associated with the ground-truth fault image, wherein the training includes:
generating, using a generator of the image prediction model, a predicted fault image based on the noise image and the fault type,
determining, using a discriminator of the image prediction model, whether a difference between the predicted fault image and the ground-truth fault image is less than a specified threshold, and
iteratively training the image prediction model until the difference is reduced.

7. The method of claim 6, wherein training the image prediction model includes:
applying spectral normalization to adjust a Lipschitz constant of the discriminator.

8. The method of claim 6, wherein training the image prediction model includes:
determining, using a noise generator model, a noise controlling parameter, which is used to control amount of noise added to the noise image,
modifying the noise image based on the noise controlling parameter to generate noisy image data; and
inputting the noisy image data to the generator to generate the predicted fault image.

9. The method of claim 8, wherein determining the noise controlling parameter includes:
obtaining a loss associated with the generator during training of the image prediction model; and
determining, using the noise generator model, the noise controlling parameter based on the loss.

10. The method of claim 8, wherein the noise controlling parameter includes:
a first noise controlling parameter and a second noise controlling parameter that is used to add noise to the noise image, wherein the first noise controlling parameter is greater than the second noise controlling parameter.

11. The method of claim 8, wherein determining the noise controlling parameter includes:
generating a plurality of noise training datasets, wherein each noise training dataset includes a loss associated with a generator of a second image prediction model and multiple noise controlling parameters generated for the loss, wherein the noise controlling parameters include a first noise controlling parameter that is computed when the loss is greater than a threshold loss, and a second noise controlling parameter that is computed when the loss is lesser than or equal to the threshold loss; and
training the noise generator model with the noise training datasets to generate the noise controlling parameter.

12. The method of claim 11, wherein generating the plurality of noise training datasets includes:
training the second image prediction model to generate a training image that is representative of a given type of fault, wherein the training includes:
generating, using the generator of the second image prediction model, the training image based on random image data,
determining, using a discriminator of the second image prediction model, whether a difference between the training image and a source image representative of the given type of fault is less than a specified threshold,
computing the loss associated with the generator of the second image prediction model,
determining the noise controlling parameter based on comparing the loss with the threshold loss, and
iteratively training the second image prediction model until the difference is reduced to generate a set of losses and their associated noise parameters as the noise training datasets.

13. The method of claim 1, wherein converting the vibration signal data to a first image includes:
segmenting the vibration signal data into multiple segments,
computing a Gram tensor for a first segment of the segments, and
generating the first image based on the Gram tensor, where tensor values from the Gram tensor are mapped to pixel values of the first image.

14. A non-transitory computer-readable storage medium for storing computer-readable instructions that, when executed by a computer, cause the computer to perform a method of training an image prediction model to generate training data for training a fault prediction model to predict a fault type of a bearing based on an image representative of characteristics of the bearing, the method comprising:
obtaining multiple sets of data, wherein each set of data includes (a) noise image, (b) a ground-truth fault image representative of one of multiple types of a fault of a bearing in a machine, and (c) a fault type associated with the ground-truth fault image, wherein the training includes:
training an image prediction model using the sets of data to generate a specified fault image for a specified fault type, wherein the training includes:
generating, using a generator of the image prediction model, a predicted fault image based on the noise image and the fault type,
determining, using a discriminator of the image prediction model, whether a difference between the predicted fault image and the ground-truth fault image is less than a specified threshold, and
iteratively training the image prediction model until the difference is reduced.

15. The computer-readable storage medium of claim 14, wherein the method of training the image prediction model includes:
applying spectral normalization to adjust a Lipschitz constant of the discriminator.

16. The computer-readable storage medium of claim 14, wherein the method of training the image prediction model includes:
determining, using a noise generator model, a noise controlling parameter, which is used to control amount of noise added to the noise image,
modifying the noise image based on the noise controlling parameter to generate noisy image data; and
inputting the noisy image data to the generator to generate the predicted fault image.

17. The computer-readable storage medium of claim 16, wherein the method of determining the noise controlling parameter includes:
obtaining a loss associated with the generator during training of the image prediction model, and
determining, using the noise generator model, the noise controlling parameter based on the loss.

18. The computer-readable storage medium of claim 14, wherein the method further includes:
during an inference stage, inputting multiple noise images and associated fault types to the image prediction model, wherein each noise image is associated with one of the fault types, and
executing the image prediction model to generate multiple fault images, wherein the fault images include one or more fault images for each of the fault types.

19. The computer-readable storage medium of claim 18, wherein the method further comprises:
training a fault prediction model with the fault images as training data to predict a fault type of the bearing for an input image, wherein the training includes:
generating a feature vector combination from a first fault image of the fault images, wherein the feature vector combination is a combination of (a) location-agnostic and channel-specific features and (b) location-specific and channel-agnostic features of the first fault image,
generating a predicted fault type associated with the first fault image based on the feature vector combination, and
performing the training until a first loss function associated with the fault prediction model is reduced, wherein the first loss function is indicative of a difference between ground-truth fault type associated with the first fault image and the predicted fault type.

20. The computer-readable storage medium of claim 19, wherein the method further comprises:
obtaining vibration signal data that is representative of characteristics of the bearing, wherein the vibration signal data includes a one-dimensional time domain signal;
converting the vibration signal data to a first image, wherein the first image is a two-dimensional grayscale image representation of the vibration signal data; and
executing the fault prediction model by inputting the first image to determine a type of fault in the bearing, wherein the executing includes:
extracting, using a feature extraction model, multiple feature vectors from the first image that are representative of the characteristics of the bearing, wherein the feature vectors are extracted using location-agnostic convolution operation and location-specific involution operation, and
determining, by the fault prediction model, the type of fault in the bearing based on the feature vectors.
